(19) United States
(12) Patent Application Publication
(10) Pub. No.: US 2024/0393660 A1
(43) Pub. Date: Nov. 28, 2024

(54) CAMERA PERFORMING OIS FUNCTION AND ELECTRONIC DEVICE INCLUDING THE SAME

(71) Applicant: SAMSUNG ELECTRONICS CO., LTD., Suwon-si (KR)

(72) Inventor: Youngjae HWANG, Suwon-si (KR)

(73) Assignee: SAMSUNG ELECTRONICS CO., LTD., Suwon-si (KR)

(21) Appl. No.: 18/786,029

(22) Filed: Jul. 26, 2024

Related U.S. Application Data
(63) Continuation of application No. PCT/KR2024/006800, filed on May 20, 2024.

(30) Foreign Application Priority Data
May 22, 2023 (KR) 10-2023-0065793
Jul. 10, 2023 (KR) 10-2023-0089430

(51) Int. Cl. G03B 5/00; G02B 7/02; G02B 27/64

(52) U.S. Cl. CPC G03B 5/00; G02B 7/021; G02B 27/646; G03B 2205/0069

(57) ABSTRACT

An electronic device includes a lens assembly aligned along an optical axis; a first carrier coupled to the lens assembly and having a first accommodating groove therein; a second carrier coupled to the first carrier and having a second accommodating groove therein; at least one first guide plate coupled to the first accommodating groove in the first carrier, the at least one first guide plate having a first surface; at least one second guide plate coupled to the second accommodating groove in the second carrier, the at least one second guide plate having a second surface that faces the first surface of the at least one first guide plate; and a guide ball on the second surface and accommodated in at least part of a space formed by the second carrier, the guide ball contacting the first surface.

### CROSS-REFERENCE TO RELATED APPLICATIONS

This application is a by-pass continuation of International Application No. PCT/KR2024/006800, filed on May 20, 2024, which is based on and claims priority to Korean Patent Application No. 10-2023-0065793, filed on May 22, 2023 in the Korean Intellectual Property Office, and Korean Patent Application No. 10-2023-0089430, filed on Jul. 10, 2023 in the Korean Intellectual Property Office, the disclosures of which are incorporated by reference herein in their entireties.

### BACKGROUND

### 1. Field

The disclosure relates to a camera performing an optical image stabilization (OIS) function and an electronic device including the camera.

### 2. Description of Related Art

Cameras applied to mobile phones can be positioned in at least one of the front and back of the mobile phones and operate to present the function of taking photos and videos. The cameras can include actuators for moving at least part of an optical system or an image sensor and acquiring clear photos and videos, for the sake of OIS and auto focus (AF) functions, when a user takes photos or video.

OIS is a method of reducing shaking by moving a lens assembly or image sensor included in a camera module. At this time, the lens assembly or the image sensor must move only in a specific direction in consideration of a user's movement, and if unnecessary rotation or tilt occurs, stable OIS cannot be performed.

In a camera module, a guide member having a certain thickness can be additionally presented to stabilize the directionality of movement of the lens assembly or the image sensor. When the guide member is additionally presented to the camera module, its volume and thickness can also increase.

### SUMMARY

One or more embodiments of the disclosure provide a structure in which the directionality of movement of a carrier (e.g., OIS carrier or AF carrier) may be stabilized, without a separate guide member, in a camera module.

Technical tasks sought to be achieved in this document are not limited to the technical tasks mentioned above, and other technical tasks not mentioned may be clearly understood by those skilled in the art to which this document pertains, from the following description.

According to an aspect of the disclosure, a camera module includes: a lens assembly aligned along an optical axis; a first carrier coupled to the lens assembly and having a first accommodating groove therein; a second carrier coupled to the first carrier and having a second accommodating groove therein; at least one first guide plate coupled to the first accommodating groove in the first carrier, the at least one first guide plate having a first surface; at least one second guide plate coupled to the second accommodating groove in the second carrier, the at least one second guide plate having a second surface that faces the first surface of the at least one first guide plate; and a guide ball on the second surface of the at least one second guide plate and accommodated in at least part of a space formed by the second carrier, the guide ball contacting the first surface of the at least one first guide plate.

The at least one first guide plate may include a dipole magnet, and each of the at least one second guide plate and the guide ball may include a ferromagnet.

The at least one first guide plate may include a first-first guide plate, a second-first guide plate, a third-first guide plate, and a fourth-first guide plate, each of the first-first guide plate, the second-first guide plate, the third-first guide plate, and the fourth-first guide plate may include a dipole magnet, the first-first guide plate, the second-first guide plate, the third-first guide plate, and the fourth-first guide plate may be respectively arranged in a plurality of corner regions of the first carrier, the first-first guide plate may be positioned diagonally with respect to the third-first guide plate, and a first boundary line dividing a north pole and a south pole of the first-first guide plate may be orthogonal to a second boundary line dividing a north pole and a south pole of the second-first guide plate.

The at least one first guide plate may include a dipole magnet including a north pole, a south pole, and the at least one first guide plate may be configured to allow the guide ball to move along a boundary line between the north pole and the south pole and to assert a return force when the guide ball moves perpendicular to the boundary line.

The at least one first guide plate may include a plurality of first guide plates, the at least one second guide plate may include a plurality of second guide plates, the first carrier may have a plurality of first accommodating grooves in a plurality of corner regions thereof, and the plurality of first guide plates may be respectively coupled to the plurality of first accommodating grooves, and the second carrier may have a plurality of second accommodating grooves in a plurality of corner regions thereof, and the plurality of second guide plates may be respectively coupled to the plurality of second accommodating grooves.

Each of the at least one first guide plate and the at least one second guide plate may include a dipole magnet including a north pole and a south pole.

A north-pole region of the at least one first guide plate may extend along the optical axis and may coincide with a south-pole region of the at least one second guide plate, and a south-pole region of the at least one first guide plate may extend along the optical axis and may coincide with a north-pole region of the at least one second guide plate.

At least one of the at least one first guide plate or the at least one second guide plate has a circular shape, the guide ball may include a ferromagnet including a spherical shape, and a diameter of the circular shape may be larger than a diameter of the spherical shape.

At least one of the at least one first guide plate or the at least one second guide plate may have a square shape, the guide ball may include a ferromagnet having a spherical shape, and a length of a side of the square shape may be larger than a diameter of the spherical shape.

At least one of the at least one first guide plate or the at least one second guide plate may include an oval shape.

The guide ball may include a ferromagnet having a spherical shape, and at least one of the at least one first guide plate or the at least one second guide plate may include a dipole magnet including a north pole, a south pole, and a neutral zone where the guide ball may move along a boundary line between the north pole and the south pole, the neutral zone being formed on a long axis of the at least one of the at least one first guide plate or the at least one second guide plate including the oval shape.

The at least one first guide plate may include a dipole magnet formed via a magnetization process applied to the at least one first guide plate after the at least one first guide plate is coupled to the first accommodating groove.

The first carrier may include an optical image stabilization carrier configured to move the lens assembly on a plane perpendicular to the optical axis, and the second carrier may include an auto focus carrier configured to move the lens assembly in an optical-axis direction.

According to an aspect of the disclosure, a camera module includes: a lens assembly aligned along an optical axis; a housing accommodating the lens assembly and having a first accommodating groove therein; a circuit board on which an image sensor is disposed; a carrier configured to move the circuit board within the camera module in an optical-axis direction and a direction crossing the optical axis, the carrier having a second accommodating groove therein; at least one first guide plate coupled to the first accommodating groove in the housing, the at least one first guide plate having a first surface; at least one second guide plate coupled to the second accommodating groove in the carrier, the at least one second guide plate having a second surface that faces the first surface of the at least one first guide plate; and a guide ball on the second surface of the at least one second guide plate and accommodated in at least part of a space formed by the carrier, the guide ball contacting with the first surface of the at least one first guide plate.

The at least one first guide plate may include a dipole magnet, and each of the at least one second guide plate and the guide ball may include a ferromagnet.

The at least one first guide plate may include a first-first guide plate, a second-first guide plate, a third-first guide plate, and a fourth-first guide plate, each of the first-first guide plate, the second-first guide plate, the third-first guide plate, and the fourth-first guide plate may include a dipole magnet, the first-first guide plate, the second-first guide plate, the third-first guide plate, and the fourth-first guide plate are respectively arranged in a plurality of corner regions of the housing, the first-first guide plate may be positioned diagonally with respect to the third-first guide plate, and a first boundary line dividing a north pole and a south pole of the first-first guide plate may be orthogonal to a second boundary line dividing a north pole and a south pole of the second-first guide plate.

The at least one first guide plate may include a dipole magnet including a north pole and a south pole, and the at least one first guide plate may be configured to allow the guide ball to move along a boundary line between the north pole and the south pole, and to assert a return force when the guide ball moves perpendicular to the boundary line.

The at least one first guide plate may include a plurality of first guide plates, and the at least one second guide plate may include a plurality of second guide plates, the housing has a plurality of first accommodating grooves in a plurality of corner regions thereof, and the plurality of first guide plates are respectively coupled to the plurality of first accommodating grooves, and the carrier has a plurality of second accommodating grooves in a plurality of corner regions thereof, and the plurality of second guide plates are respectively coupled to the plurality of second accommodating grooves.

According to an aspect of the disclosure, a method of manufacturing a camera module, includes: coupling a first guide plate to a lower surface of a first carrier; coupling a second guide plate to an upper surface or a lower surface of a second carrier; placing a guide ball on the second guide plate in an accommodating space of the second carrier; and coupling the first carrier and the second carrier such that the guide ball is between the first guide plate and the second guide plate.

The coupling the first guide plate to the lower surface of the first carrier may include: coupling the first guide plate to an accommodating groove formed in the first carrier; and magnetizing the first guide plate after the coupling the first guide plate to the accommodating groove.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an exploded perspective view of a camera module presented with a guide member;

FIG. 2 illustrates a structure presented in place of a guide member in an electronic device according to an embodiment;

FIG. 3 illustrates a guide unit (a first guide plate, a guide ball, and a second guide plate) according to an embodiment;

FIGS. 4 and 5 are development plans illustrating a construction of a camera module including a guide unit according to an embodiment;

FIGS. 6 and 7 are development plans for explaining a seating position of a guide ball according to an embodiment;

FIG. 8 is a diagram for explaining a coupling position of a first guide plate according to an embodiment;

FIG. 9 is a diagram for explaining a coupling direction of a first guide plate according to an embodiment;

FIGS. 10 and 11 are diagrams for explaining an accommodating space of a second carrier and an accommodating groove for a second guide plate according to an embodiment;

FIG. 12 is a diagram illustrating a state in which a guide ball is seated in an accommodating space of a second carrier according to an embodiment;

FIG. 13 is a diagram for explaining a state of coupling between a first carrier and a second carrier according to an embodiment;

FIGS. 14 and 15 illustrate a construction of a camera module including a guide unit according to an embodiment when using a sensor shift method;

FIGS. 16 and 17 illustrate a relationship between a carrier movement and a return force;

FIG. 18 is a flowchart of a process of manufacturing a camera module according to an embodiment;

FIG. 19 is a block diagram of an electronic device in a network environment according to various embodiments; and

FIG. 20 is a block diagram of a camera module according to various embodiments.

### DETAILED DESCRIPTION

Embodiments of the disclosure will be described below in detail with reference to the accompanying drawings. The advantages and features of the disclosure and methods for achieving them will become clear by referring to the embodiments described below in detail along with the accompanying drawings. However, the disclosure is not limited to the embodiments disclosed below and may be implemented in various different forms. These embodiments are merely presented to make the disclosure complete, and completely inform the scope of the disclosure to those skilled in the art to which the disclosure pertains, and the disclosure is merely defined by the scope of the claims. Like reference numerals refer to like elements throughout the specification.

Unless otherwise defined, all terms (including technical and scientific terms) used in this specification may be used as meanings that may be commonly understood by those skilled in the art to which the disclosure pertains. Also, terms defined in commonly used dictionaries should be given their ordinary meaning unless a specific definition is provided. Terms used in this specification are to describe embodiments and are not intended to limit the disclosure. In this specification, singular forms also include plural forms unless specifically stated otherwise in the context.

As used in the specification, “comprises” and/or “comprising” does not exclude the presence or addition of one or more other components, steps, operations, and/or elements, in addition to the mentioned components, steps, operations, and/or elements.

Herein, the expressions “at least one of a, b or c” and “at least one of a, b and c” indicate “only a,” “only b,” “only c,” “both a and b,” “both a and c,” “both b and c,” or “all of a, b, and c.”

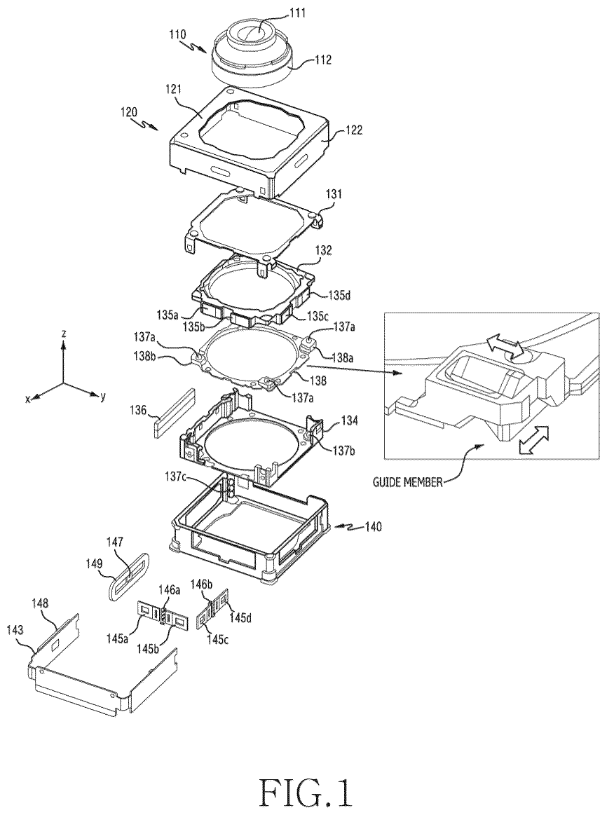

FIG. 1 illustrates an exploded perspective view of a camera module presented with a guide member.

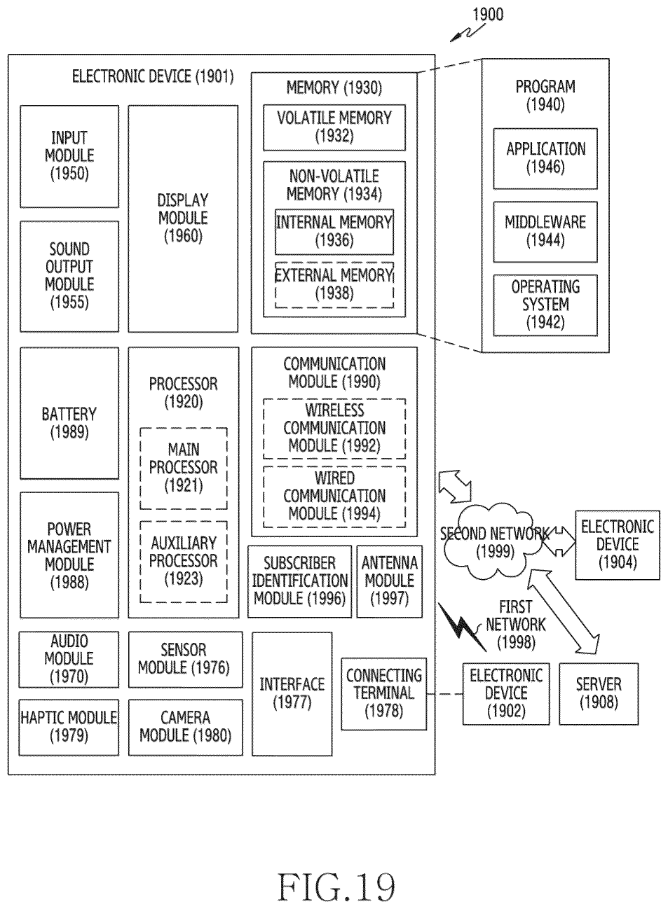

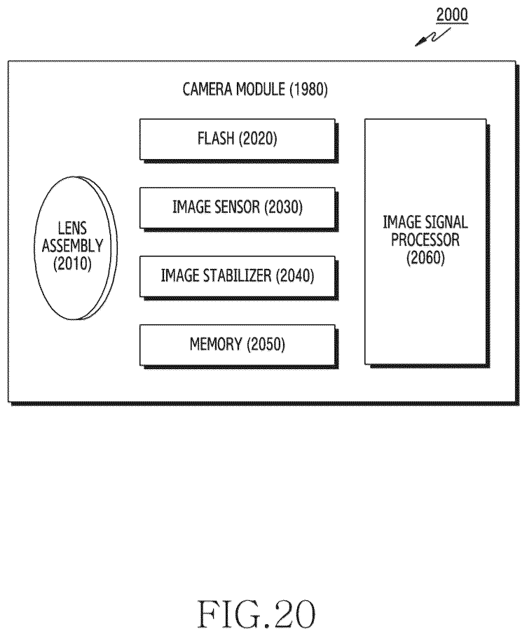

Referring to FIG. 1, the camera module (e.g., camera module 1980 in FIGS. 19 and 20) may include a lens assembly 110, an optical image stabilization (OIS) carrier 132, and a housing 140. The camera module may further include a shield can 120 and an auto focusing (AF) carrier 134.

The camera module may include the lens assembly 110 aligned along an optical axis (e.g., z-axis). The lens assembly 110 may include a lens 111 and a lens barrel 112. For example, the lens 111 may collect light incident from the outside and transmit the light to an image sensor disposed below the lens barrel 112. The lens 111 may be comprised of one lens or a plurality of lenses aligned along the optical axis. The lens 111 may be fixed to one side of the lens barrel 112. The lens barrel 112 may surround the seated lens 111 and fix the lens 111. The lens barrel 112 may present an optical path that may transmit light, which is incident along the optical axis (e.g., z-axis) through the lens 111, to the image sensor arranged in a −z direction of the lens assembly 110. In this regard, a center portion of the lens barrel 112 may be empty, and a lower portion may be open to expose the image sensor. An upper side of the lens barrel 112 may be presented in a form corresponding to the shape of the lens 111. The lens barrel 112 may be seated and fixed inside the OIS carrier 132. The lens assembly 110 (or the lens barrel 112 and the lens 111) may be moved on a plane substantially perpendicular to the optical axis or may be moved along the optical axis, according to the movement of the OIS carrier 132 or the AF carrier 134.

The shield can 120 may be presented in a form of covering the camera module as a whole from top (e.g., +z direction) to bottom (e.g., −z direction). For example, the shield can 120 may include an upper surface 121 and shield can side walls 122 arranged at edges of the upper surface 121, and may include a lower surface presented in an open form. An opening of a preset size may be presented in the upper surface 121 of the shield can 120 and expose at least part of the lens 111. The shield can side walls 122 may be combined with edges of the housing 140 of the camera module and perform a role of protecting or fixing components (e.g., the lens assembly 110, the OIS carrier 132, the AF carrier 134, and the housing 140). The shield can 120, for example, may be formed of a metal material or be formed of a material (e.g., a metal material or a reinforced plastic) having a hardness equal to or larger than a specified size.

The camera module may include the OIS carrier 132 and the AF carrier 134. For example, the lens barrel 112 may be arranged inside the OIS carrier 132. The lens assembly 110 may be coupled with the OIS carrier 132 and be moved together. For example, the OIS carrier 132 may be moved within the AF carrier 134 in a direction substantially perpendicular to the optical axis, for example, in an x-axis or y-axis direction. The OIS carrier 132 may be coupled with the lens assembly 110 and be accommodated in a space inside the AF carrier 134. For example, the OIS carrier 132 may be seated at a center portion of the AF carrier 134.

A first OIS magnet 135a and a second OIS magnet 135b may be disposed on a first side surface (e.g., an outer side surface of +x direction) of the OIS carrier 132. The first OIS magnet 135a and the second OIS magnet 135b may be disposed side by side along a direction (e.g., y-axis direction) substantially perpendicular to the optical axis (e.g., z-axis), on the first side surface. The first OIS magnet 135a and the second OIS magnet 135b may each be a polarized magnet.

A third OIS magnet 135c and a fourth OIS magnet 135d may be disposed on a second side surface (e.g., an outer side surface of +y direction) of the OIS carrier 132. The first side surface and second side surface of the OIS carrier 132 may be substantially perpendicular outer side surfaces. The third OIS magnet 135c and the fourth OIS magnet 135d may be disposed side by side along a direction (e.g., x-axis direction) substantially perpendicular to the optical axis (e.g., z-axis), on the second side surface. The third OIS magnet 135c and the fourth OIS magnet 135d may each be a polarized magnet.

The AF carrier 134 may include at least one carrier side wall. For example, the AF carrier 134 may include a side wall formed to expose the first OIS magnet 135a and the second OIS magnet 135b, which operate to move, in an x-axis direction, the OIS carrier 132 on which the lens assembly 110 is seated. Also, the AF carrier 134 may include a side wall formed to expose the third OIS magnet 135c and the fourth OIS magnet 135d, which operate to move, in a y-axis direction, the OIS carrier 132 on which the lens assembly 110 is seated. Also, the AF carrier 134 may include a side wall which an AF magnet 136, which is used to move the lens assembly 110 in an optical-axis (e.g., z-axis) direction, is disposed outside.

The camera module may include a cover 131 (or OIS cover). For example, the cover 131 may be presented in a form of covering the OIS carrier 132 and the AF carrier 134 from top to bottom. The cover 131 may prevent the OIS carrier 132 from leaving the AF carrier 134. In this regard, the cover 131 may include an upper substrate and leads. The upper substrate of the cover 131 may have a circular or polygonal band (e.g., square band) shape having an empty center, and may include a cover hole of a preset size in a center portion wherein at least part of the lens 111 may be exposed. The leads of the cover 131 may be formed to have a preset length and width directly downward (e.g., −z direction) from one side (e.g., corner region) of the upper substrate. The leads may be presented in a ring shape having an empty center, and be coupled to one side of the AF carrier 134.

The camera module may include a first OIS coil member 145a fixed to the housing 140 and facing the first OIS magnet 135a, a second OIS coil member 145b fixed to the housing 140 and facing the second OIS magnet 135b, a third OIS coil member 145c fixed to the housing 140 and facing the third OIS magnet 135c, and a fourth OIS coil member 145d fixed to the housing 140 and facing the fourth OIS magnet 135d. The first OIS coil member 145a and the second OIS coil member 145b may be fixed to and disposed on a first inner surface of the housing 140 facing the first side surface of the OIS carrier 132. The third OIS coil member 145c and the fourth OIS coil member 145d may be fixed to and disposed on a second inner surface of the housing 140 facing the second side surface of the OIS carrier 132.

The first OIS magnet 135a, second OIS magnet 135b, third OIS magnet 135c, and fourth OIS magnet 135d for hand shake correction (e.g., optical image stabilizer (OIS)) may be operated in pairs with hand shake correction related coil members (e.g., the first OIS coil member 145a, second OIS coil member 145b, third OIS coil member 145c, and fourth OIS coil member 145d) arranged in the housing 140. For example, when current is applied to the first OIS coil member 145a, the lens assembly 110 may be moved along a direction (e.g., x-axis direction) substantially perpendicular to the optical axis, due to electromagnetic interaction between the first OIS coil member 145a and the first OIS magnet 135a. For another example, when current is applied to the first OIS coil member 145a and the second OIS coil member 145b, the lens assembly 110 may be moved along a direction (e.g., x-axis direction) substantially perpendicular to the optical axis, due to electromagnetic interaction between the first OIS coil member 145a and the first OIS magnet 135a and electromagnetic interaction between the second OIS coil member 145b and the second OIS magnet 135b. For further example, when current is applied to the third OIS coil member 145c and the fourth OIS coil member 145d, the lens assembly 110 may be moved along another direction (e.g., y-axis direction) substantially perpendicular to the optical axis, due to electromagnetic interaction between the third OIS coil member 145c and the third OIS magnet 135c and electromagnetic interaction between the fourth OIS coil member 145d and the fourth OIS magnet 135d.

The AF magnet 136 for automatic focus adjustment (e.g., auto focus (AF)) may be operated in a pair with an AF coil 149 arranged in the housing 140. For example, when current is applied to the AF coil 149, the lens assembly 110 may be moved along a direction (e.g., +z/−z-axis direction) parallel to the optical axis, due to electromagnetic interaction between the AF coil 149 and the AF magnet 136.

The camera module may include a first position sensor 146a fixed to the housing 140, between the first OIS coil member 145a and the second OIS coil member 145b. Also, the camera module may include a second position sensor 146b fixed to the housing 140, between the third OIS coil member 145c and the fourth OIS coil member 145d. For example, the first position sensor 146a and/or the second position sensor 146b may each be a Hall sensor. The camera module (or a driving circuit included in the camera module) may measure a position of the lens assembly 110 by using at least one of the first position sensor 146a or the second position sensor 146b. For example, the camera module may measure a position, on x-axis, of the lens assembly 110 (e.g., a distance between the first position sensor 146a and the lens assembly 110) by using the first position sensor 146a, and may measure a position, on y-axis, of the lens assembly 110 (e.g., a distance between the second position sensor 146b and the lens assembly 110) by using the second position sensor 146b. The driving circuit may identify a position of an OIS magnet, based on the amount of a magnetic flux provided by the OIS magnet (e.g., the first OIS magnet 135a, the second OIS magnet 135b, the third OIS magnet 135c, and the fourth OIS magnet 135d), which is measured through a position sensor (e.g., the first position sensor 146a and the second position sensor 146b), and may identify a position of the lens assembly 110, based on the position of the OIS magnet. For example, the driving circuit may measure a position, on x-axis, of the lens assembly 110, based on a magnetic flux provided by the first OIS magnet 135a and the second OIS magnet 135b, which is measured through the first position sensor 146a.

The camera module may include an AF position sensor 147 arranged adjacent to the AF coil 149 (e.g., disposed inside the AF coil 149). The camera module (or the driving circuit included in the camera module) may measure a position, in an optical-axis (e.g., z-axis) direction, of the lens assembly 110 by using the AF position sensor 147. For example, the driving circuit may identify a position, on z-axis, of the AF coil 149, based on the amount of a magnetic flux provided by the AF coil 149, which is measured through the AF position sensor 147. The driving circuit may identify a position, in the optical-axis direction, of the lens assembly 110, based on the position, on z-axis, of the AF coil 149.

The thickness of the first position sensor 146a, the second position sensor 146b, and the AF position sensor 147 may be formed to be greater than the thickness of the coil members (e.g., the first OIS coil member 145a, the second OIS coil member 145b, the third OIS coil member 145c, the fourth OIS coil member 145d, and the AF coil 149). For example, the thickness of the first OIS coil member 145a and the second OIS coil member 145b may be formed to be smaller than the thickness of the first position sensor 146a. Also, the thickness of the third OIS coil member 145c and the fourth OIS coil member 145d may be formed to be smaller than the thickness of the second position sensor 146b. The thickness of the AF coil 149 may be smaller than the thickness of the AF position sensor 147.

The first OIS coil member 145a, the second OIS coil member 145b, the third OIS coil member 145c, and the fourth OIS coil member 145d may be fine pattern (FP) coils. For example, the first OIS coil member 145a may be a coil that a pattern each corresponding to at least one coil is drawn. Also, the second OIS coil member 145b may be a coil that a pattern each corresponding to at least one coil is drawn. The AF coil 149 may be a winding coil.

Side walls of the housing 140 may be combined with the shield can side walls 122 while protecting components (e.g., the lens assembly 110 and the OIS carrier 132) arranged therein.

The first position sensor 146a, the second position sensor 146b, and the AF position sensor 147 may be electrically connected to a printed circuit board 143 (e.g., a flexible printed circuit board (FPCB)). The first OIS coil member 145a, the second OIS coil member 145b, the third OIS coil member 145c, the fourth OIS coil member 145d, and the AF coil 149 may be electrically connected to the printed circuit board 143. A driving circuit may be further disposed on the printed circuit board 143. The driving circuit may be electrically connected to at least one of the first OIS coil member 145a, the second OIS coil member 145b, the third OIS coil member 145c, the fourth OIS coil member 145d, the AF coil 149, the first position sensor 146a, the second position sensor 146b, or the AF position sensor 147.

The printed circuit board 143 may supply signals (e.g., current) to the coil members 145a, 145b, 145c, 145d, and 149 arranged in the housing 140. For example, the printed circuit board 143 may be connected to a driving circuit related to camera module driving or an application processor (AP) of an electronic device (e.g., an electronic device 1901 of FIG. 19) on which the camera module is seated. Under the control of at least one of the driving circuit and the AP, the printed circuit board 143 may supply a signal of a specified magnitude (e.g., a current of a specified magnitude) to at least one of the coil members 145a, 145b, 145c, 145d, and 149 fixed to the housing 140. The printed circuit board 143 may receive sensing values from the position sensors 146a, 146b, and 147 arranged in the housing 140, and may supply corresponding signals to the coil members 145a, 145b, 145c, 145d, and 149, respectively.

The driving circuit may control a current applied to at least one of the first OIS coil member 145a, the second OIS coil member 145b, the third OIS coil member 145c, or the fourth OIS coil member 145d and move the lens assembly 110 in a direction (e.g., x-axis direction and y-axis direction) substantially perpendicular to the optical axis (e.g., z-axis). Also, the driving circuit may control a current applied to the AF coil 149 and move the lens assembly 110 along the optical axis (e.g., z-axis). The driving circuit may measure a position of the lens assembly 110 by using any one of the first position sensor 146a, the second position sensor 146b, or the AF position sensor 147. The driving circuit may change signals applied to the coil members (e.g., the first OIS coil member 145a, the second OIS coil member 145b, the third OIS coil member 145c, the fourth OIS coil member 145d, and the AF coil 149), based on acquired information about the position of the lens assembly 110.

The camera module of FIG. 1 may include a guide member 138 and guide balls 137a and 137b for guiding and supporting the movement of the OIS carrier 132. For example, the first guide balls 137a may be arranged between the OIS carrier 132 and the guide member 138. Through the first guide balls 137a, the OIS carrier 132 may move forward and backward in an x-axis direction (or y-axis direction). The second guide balls 137b may be arranged between the guide member 138 and the AF carrier 134. Through the second guide balls 137b, the guide member 138 may move forward and backward in a y-axis direction (or x-axis direction), whereby the OIS carrier 132 may move forward and backward in the y-axis direction (or x-axis direction). The OIS carrier 132, the guide member 138, and the AF carrier 134 may be presented with guide grooves (e.g., 138a and 138b) in which the guide balls 137a and 137b are accommodated. The first guide groove 138a may be formed in a surface, in +z-axis direction, of the guide member 138. The second guide groove 138b may be formed in a surface, in-z-axis direction, of the guide member 138. For example, the guide grooves (e.g., 138a and 138b) may extend along a specified direction (e.g., x-axis or y-axis direction), and have a V- or U-shaped cross-sectional shape. The guide grooves (e.g., 138a and 138b) may restrict the OIS carrier 132 from flowing in a direction other than the specified direction (e.g., x-axis or y-axis direction). When the OIS carrier 132 moves forward and backward in the x-axis or y-axis direction, the guide balls 137a and 137b may perform rolling in the guide grooves (e.g., 138a and 138b).

At least one side wall of the AF carrier 134 may be presented with AF guide grooves and AF guide balls 137c for guiding and supporting the flow of the AF carrier 134. For example, the AF guide grooves may restrict the AF carrier 134 from flowing in a direction other than a specified direction (e.g., z-axis direction) within the housing 140. The AF guide grooves may extend along the specified direction (e.g., z-axis direction) and have a V- or U-shaped cross-sectional shape. When the AF carrier 134 moves forward and backward in the specified direction (e.g., z-axis direction), the AF guide balls 137c may roll in the AF guide grooves.

The camera module may include the housing 140 for accommodating the lens assembly 110, the OIS carrier 132, and the AF carrier 134. The housing 140 may include a seating portion on which at least the lens assembly 110, the OIS carrier 132 and the AF carrier 134 are seated, and housing side walls arranged to surround at least the above components. An opening through which an image sensor may be exposed may be formed in the seating portion of the housing 140. The first OIS coil member 145a and the second OIS coil member 145b may be disposed on a first inner surface among inner side surfaces of the housing 140, and interoperate with the first OIS magnet 135a and second OIS magnet 135b disposed on the OIS carrier 132 and move the lens assembly 110 in the x-axis direction. Also, the third OIS coil member 145c and the fourth OIS coil member 145d may be disposed on a second inner surface among the inner side surfaces of the housing 140, and interoperate with the third OIS magnet 135c and fourth OIS magnet 135d disposed on the OIS carrier 132 and move the lens assembly 110 in the y-axis direction. The AF coil 149 may be disposed on a third inner surface among the inner side surfaces of the housing 140, and interoperate with the AF magnet 136 disposed and move the lens assembly 110 in the z-axis direction.

An AF yoke 148 may be disposed on a surface, which faces the third inner surface on which the AF coil 149 is disposed, among outer side surfaces of the housing 140. For example, the AF coil 149 may be arranged between the AF magnet 136 and the AF yoke 148. The AF yoke 148 may improve the efficiency of the AF coil 149 by concentrating an electromagnetic force between the AF magnet 136 and the AF coil 149. Also, the AF carrier 134 may be in close contact with the third inner surface of the housing 140, due to an attractive force between the AF magnet 136 and the AF yoke 148. Accordingly, the AF guide balls 137c do not leave the AF guide grooves, and the AF carrier 134 may move smoothly forward and backward in the z-axis direction.

However, in the camera module of FIG. 1, the guide member 138 requires a minimal space for accommodating the guide balls 137a and 137b and the AF guide ball 137c, as described above. Also, there is a disadvantage in which, as the camera module is presented with the guide member 138, the thickness of the electronic device 1901 increases or the camera module protrudes from the electronic device 1901.

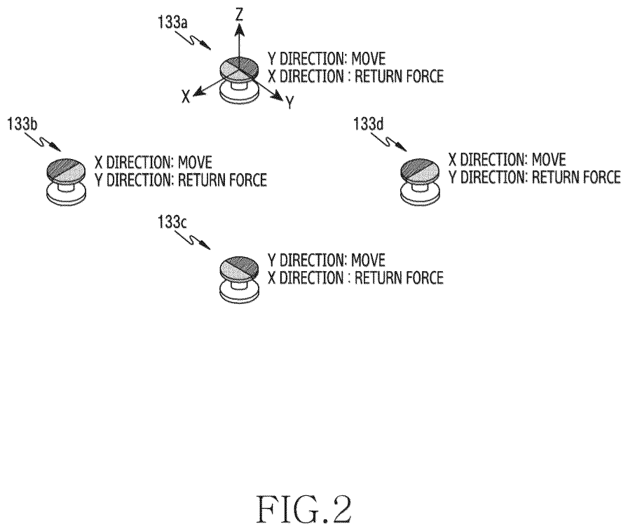

When the guide member 138 is removed from the camera module, an unintended rotation component is provided during the movement of the lens assembly 110 at a time an OIS function is performed, and this leads to the deterioration of a resolution. Therefore, a separate construction and structure capable of replacing the guide member 138 of FIG. 1 is needed. The construction and structure for replacing the guide member 138 will be described in detail with reference to FIGS. 2 to 5.

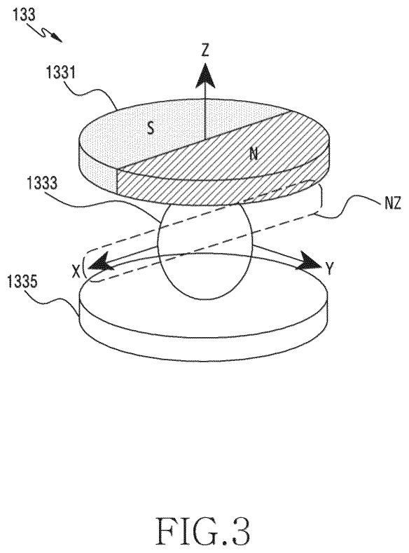

FIG. 2 illustrates a structure presented by replacing a guide member in an electronic device according to an embodiment, and FIG. 3 illustrates a guide unit (a first guide plate, a guide ball, and a second guide plate) according to an embodiment.

Referring to FIG. 2, a plurality of guide units 133 (133a, 133b, 133c, and 133d) may be presented for a camera module in place of the guide member 138. The guide unit 133 may include a first guide plate 1331, a guide ball 1333, and a second guide plate 1335.

At least one of the first guide plate 1331 or the second guide plate 1335 may be comprised of a magnet. The magnet may be a dipole magnet including the north (N) pole and the south(S) pole. The magnet may be a natural material such as magnetite, or may be a material magnetized by applying an external magnetic field to a magnetic material.

Also, any one of the first guide plate 1331 or the second guide plate 1335 may be comprised of a ferromagnet. The ferromagnet, a material reacting strongly to an external magnetic field, may be made of iron, nickel, or cobalt. In an embodiment, the ferromagnet may be implemented by a material such as SUS430 or SUS304.

The guide ball 1333 of an embodiment may be comprised of a ferromagnet.

The first guide plate 1331 and the second guide plate 1335 of an embodiment may be comprised of magnets. In the first guide plate 1331 of an embodiment, an N-pole region of the first guide plate 1331 may extend along an optical axis and coincide with an S-pole region of the second guide plate 1335, and an S-pole region of the first guide plate 1331 may extend along the optical axis and coincide with an N-pole region of the second guide plate 1335.

The first guide plate 1331 of an embodiment may be comprised of a magnet, and the second guide plate 1335 may be comprised of a ferromagnet. The first guide plate 1331 of an embodiment may be comprised of a dipole magnet, and the second guide plate 1335 and the guide ball 1333 may be comprised of a ferromagnet.

The first guide plate 1331 of an embodiment may be comprised of a ferromagnet, and the second guide plate 1335 may be comprised of a magnet. The first guide plate 1331 of an embodiment may be comprised of a ferromagnet, the second guide plate 1335 may be comprised of a dipole magnet, and the guide ball 1333 may be comprised of a ferromagnet.

The first guide plate 1331 and the second guide plate 1335 of an embodiment may be arranged to contact with the spherical guide ball 1333, and the first guide plate 1331 may be maintained substantially horizontal with the second guide plate 1335.

The first guide plate 1331 of an embodiment may be presented for an upper member (e.g., an OIS carrier or a housing), and the second guide plate 1335 may be presented for a lower member (e.g., an AF carrier or a sensor carrier). The upper member is coupled to the lower member, whereby the first guide plate 1331 and the second guide plate 1335 come into contact with the guide ball 1333 in a substantially parallel state.

As illustrated in FIGS. 2 and 3, at least one of the first guide plate 1331 or the second guide plate 1335 of an embodiment may be implemented as a circular plate. Also, unlike illustrated in FIGS. 2 and 3, at least one of the first guide plate 1331 or the second guide plate 1335 of an embodiment may be implemented as a rectangular plate or an oval plate. Also, at least one of the first guide plate 1331 or the second guide plate 1335 of an embodiment may also be implemented as an octagonal plate through the chamfering of a square plate.

When the first guide plate 1331 or the second guide plate 1335 of an embodiment has an oval shape, the guide ball 1333 may be comprised of a spherical ferromagnet. At least one of the first guide plate 1331 or the second guide plate 1335 may be comprised of a dipole magnet including the N pole and the S pole. The first guide plate 1331 or the second guide plate 1335 of an embodiment may present a neutral zone (NZ) where the guide ball 1333 may move along a boundary line between the N pole and the S pole. At this time, the neutral zone (NZ) may be formed on a long axis of the oval-shaped first guide plate 1331 or second guide plate 1335.

At least one of the first guide plate 1331 or the second guide plate 1335 of an embodiment may be formed in a circular shape, and the guide ball 1333 may be comprised of a ferromagnet having a spherical shape. The diameter of the first guide plate 1331 or the second guide plate 1335 may be formed larger than the diameter of the guide ball 1333.

When at least one of the first guide plate 1331 or the second guide plate 1335 is comprised of a dipole magnet including the N pole and the S pole, the guide unit 133 of an embodiment may present a neutral zone (NZ) where the guide ball may move along a boundary line between the N pole and the S pole. When movement occurs between an upper member and a lower member, the neutral zone may guide the relative movement to occur in only one direction. For example, in FIG. 3, when a relative movement occurs between the first guide plate 1331 and the second guide plate 1335, the neutral zone may allow the movement to occur only in the direction (X-axis) of the neutral zone. When a movement occurs in a direction orthogonal to the neutral zone, the first guide plate 1331 and the second guide plate 1335 are subjected to a return force of intending to move toward the center (Z-axis).

The first guide plate 1331 of an embodiment may be comprised of a dipole magnet including the N pole and the S pole, and present a neutral zone where the guide ball may relatively move along a boundary line between the N pole and the S pole. When the guide ball 1333 moves perpendicular to the boundary line, the first guide plate 1331 of an embodiment may present the return force.

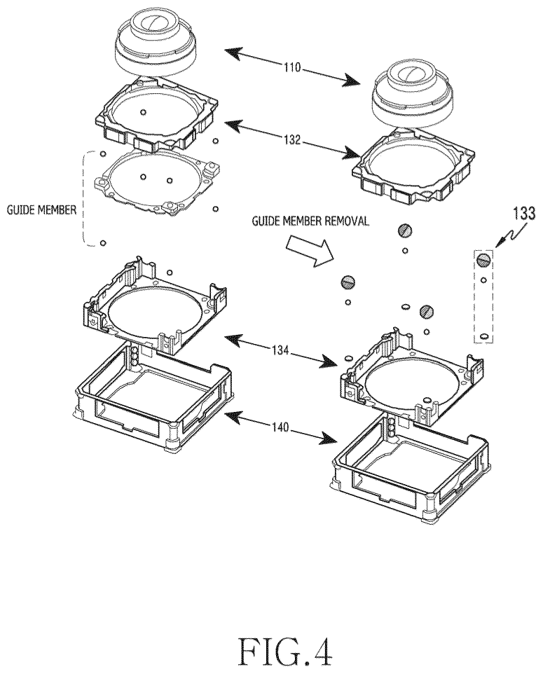

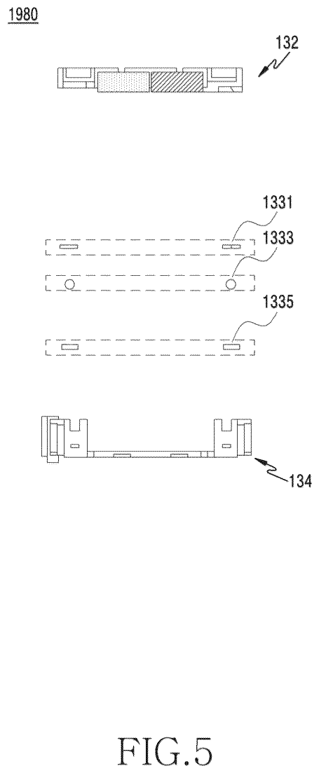

FIGS. 4 and 5 are development plans illustrating a construction of a camera module including a guide unit according to an embodiment.

FIGS. 4 and 5 are drawings for explaining a relationship of arrangement of a guide unit 133, and some components have been omitted, and the construction of FIGS. 4 and 5 may further include the remaining components excepting a guide member (e.g., the guide member 138 in FIG. 1).

In a camera module 1980 of an embodiment, the guide unit 133 may be arranged between a first carrier 132 and a second carrier 134 in place of the guide member 138 of FIG. 1.

The camera module 1980 of this embodiment adopts a lens shift method for OIS operation, and the camera module 1980 of an embodiment may include an OIS carrier and an AF carrier. The first carrier 132 of an embodiment may be the OIS carrier that moves the lens assembly on a plane substantially perpendicular to an optical axis, and the second carrier 134 may be the AF carrier that moves the lens assembly in an optical-axis direction.

A first guide plate 1331 of an embodiment may be attached to a lower surface of the first carrier 132, and a second guide plate 1335 of an embodiment may be attached to an upper surface of the second carrier 134. The first carrier 132 may be coupled with the second carrier 134 through an assembly process, whereby a guide ball 1333 may be accommodated between the first carrier 132 and the second carrier 134 with the guide ball 1333 contacting between the first guide plate 1331 and the second guide plate 1335.

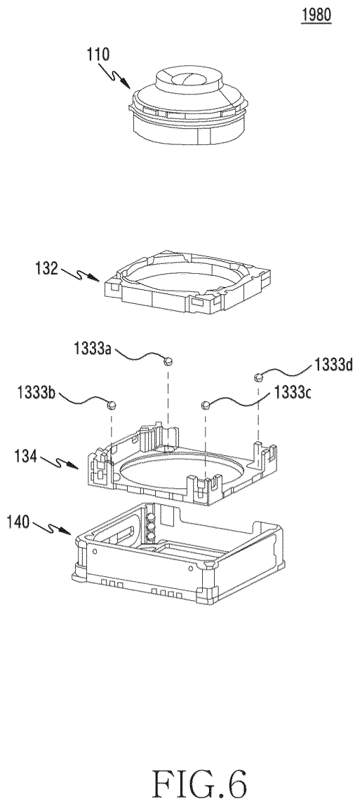

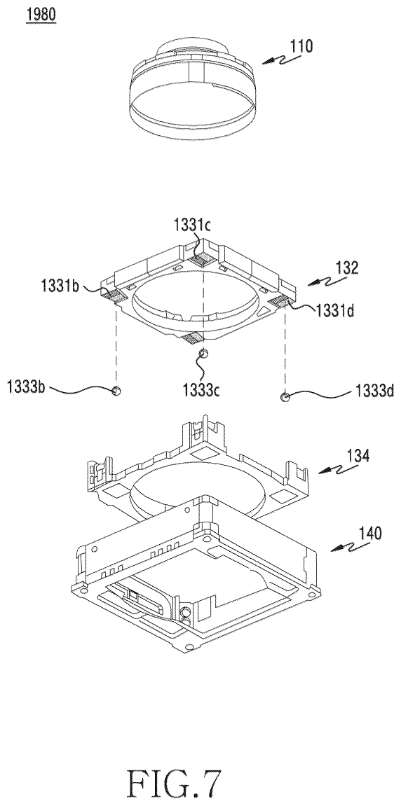

FIGS. 6 and 7 are development plans for explaining a seating position of a guide ball according to an embodiment. FIG. 6 is an exploded view of a camera module viewed from the top side, and FIG. 7 is an exploded view of the camera module viewed from the bottom side.

Referring to FIG. 6, a first guide ball 1333a, a second guide ball 1333b, a third guide ball 1333c, and a fourth guide ball 1333d may be accommodated in corner regions of a second carrier 134, respectively.

A space capable of accommodating the guide ball 1333 may be formed in the second carrier 134 of an embodiment, wherein at least part of the guide ball 1333 may be accommodated and be seated on a second guide plate 1335 (see FIG. 5).

Referring to FIGS. 6 and 7 together, the first guide ball 1333a, the second guide ball 1333b, the third guide ball 1333c, and the fourth guide ball 1333d may be accommodated in the corner regions of the second carrier 134, respectively, and simultaneously may be maintained to be attached mutually by the magnetic force of a 1-1st guide plate 1331a, a 1-2nd guide plate 1331b, a 1-3rd guide plate 1331c, and a 1-4th guide plate 1331d accommodated in corner regions of a first carrier 132.

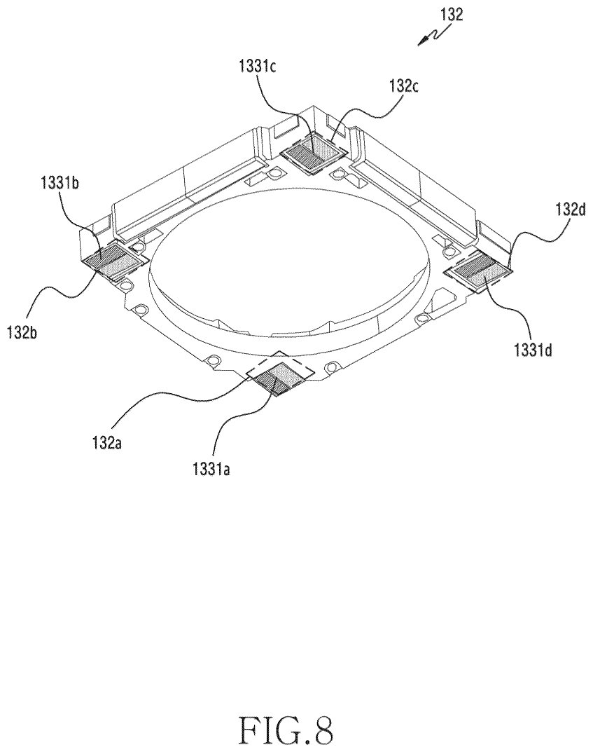

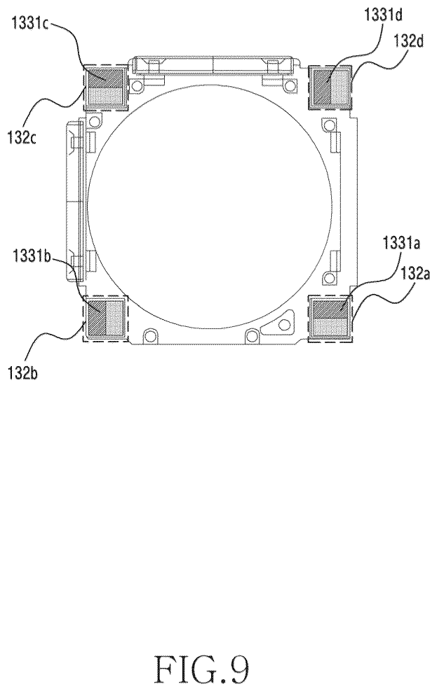

FIG. 8 is a diagram for explaining a coupling position of a first guide plate according to an embodiment, and FIG. 9 is a diagram for explaining a coupling direction of the first guide plate according to an embodiment.

Referring to FIG. 8, a first carrier 132 of an embodiment may be an OIS carrier. First accommodating grooves 132a to 132d may be engraved to accommodate a 1-1st guide plate 1331a, a 1-2nd guide plate 1331b, a 1-3rd guide plate 1331c, and a 1-4th guide plate 1331d, and may be formed in corner regions of the first carrier 132, respectively.

The shape of the first accommodating grooves 132a to 132d may be determined according to the first guide plate 1331. For example, as shown in FIG. 8, when the first guide plate 1331 is of a square type, the first accommodating grooves 132a to 132d may also be formed as the square type and match with the length of the first guide plate 1331.

The first guide plate 1331 of an embodiment may be comprised of a magnet or a ferromagnet. When the first guide plate 1331 of an embodiment is of the magnet, the first guide plate 1331 may be coupled to the first accommodating grooves 132a to 132d according to a preset array described later.

The first guide plate 1331 implemented as the magnet must be arranged according to a preset array. The first guide plate 1331 of an embodiment may include the 1-1st guide plate 1331a, the 1-2nd guide plate 1331b, the 1-3rd guide plate 1331c, and the 1-4th guide plate 1331d. The 1-1st guide plate 1331a, the 1-2nd guide plate 1331b, the 1-3rd guide plate 1331c, and the 1-4th guide plate 1331d may be arranged respectively in the first accommodating grooves 132a to 132d that are a plurality of corner regions of the first carrier 132. The 1-1st guide plate 1331a may be positioned diagonally to the 1-3rd guide plate 1331c. The N-pole direction of the 1-1st guide plate 1331a may coincide with the N-pole direction of the 1-3rd guide plate 1331c. The N-pole direction of the 1-2nd guide plate 1331b may coincide with the N-pole direction of the 1-4th guide plate 1331d. The N-pole direction of the 1-1st guide plate 1331a may be orthogonal to the N-pole direction of the 1-2nd guide plate 1331b.

According to an embodiment, a first boundary line dividing the N pole and the S pole of the 1-1st guide plate 1331a may be orthogonal to a second boundary line dividing the N pole and the S pole of the 1-2nd guide plate 1331b. At this time, the first boundary line and the second boundary line may be neutral zones (NZ) described with reference to FIG. 3.

According to a symmetrical structure of FIG. 9, a relative movement between the first carrier 132 and the second carrier 134 may occur only on a plane substantially perpendicular to an optical axis. Specifically, a guide ball 1333, which is a ferromagnet, may be guided along the neutral zone (NZ) (see FIG. 3) with being in point contact with the first guide plate 1331. When the guide ball 1333 moves in a direction orthogonal to the neutral zone (NZ), the guide plates 1331 and 1335 subjected to a return force of intending to return to a central axis (Z-axis of FIG. 3), and prevent the providing of an unintended rotation component.

The first guide plate 1331 may be coupled to the first carrier 132 in a magnetized state, but the first guide plate 1331 may be in a magnetized state through a magnetization process after the first guide plate 1331 is coupled to the first carrier 132 in an unmagnetized state. The first guide plate 1331 of an embodiment may be coupled to the first accommodating grooves 132a to 132d formed in the first carrier 132 and then be subjected to a magnetization process and become a dipole magnet. At this time, the magnetization process is performed on the 1-1st guide plate 1331a and the 1-3rd guide plate 1331c in a first direction, and the magnetization process may be performed on the 1-2nd guide plate 1331b and the 1-4th guide plate 1331d in a second direction orthogonal to the first direction.

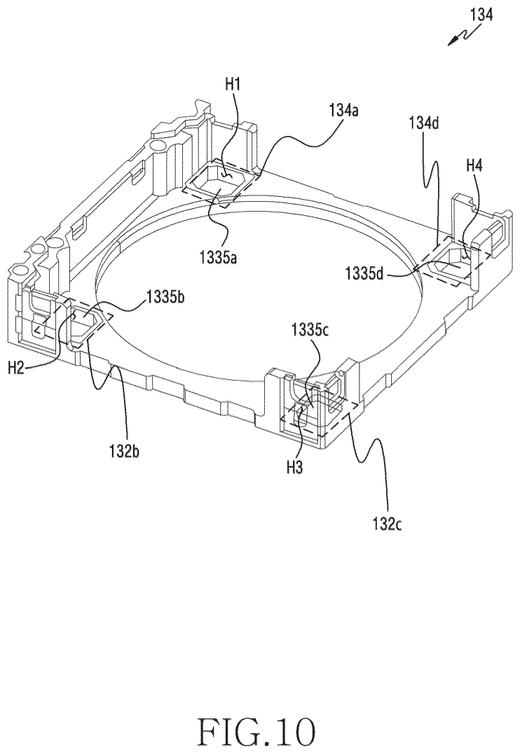

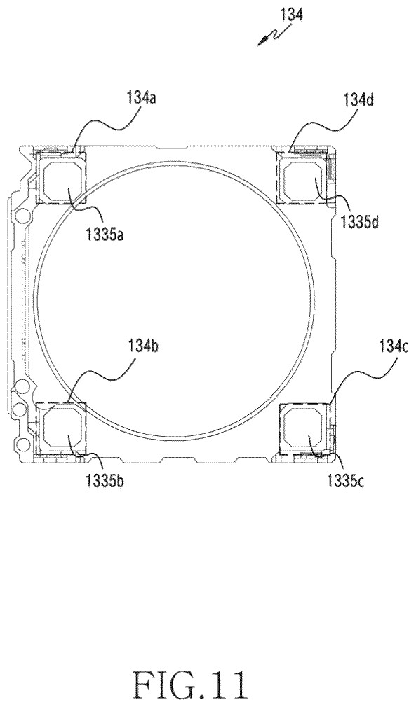

FIGS. 10 and 11 are diagrams for explaining an accommodating space of a second carrier and an accommodating groove for a second guide plate according to an embodiment.

Referring to FIG. 10, the second carrier 134 of an embodiment may be an AF carrier. Second accommodating grooves 134a to 134d may be engraved to accommodate a 2-1 st guide plate 1335a, a 2-2nd guide plate 1335b, a 2-3rd guide plate 1335c, and a 2-4th guide plate 1335d, and may be formed in corner regions of the second carrier 134, respectively.

The shape of the second accommodating grooves 134a to 134d may be determined according to the second guide plate 1335. For example, when the second guide plate 1335 is of a square type, the second accommodating grooves 134a to 134d may also be formed as the square type and match with the length of the second guide plate 1335.

The second accommodating grooves 134a to 134d may be formed in an upper surface or lower surface of the second carrier 134. When the second accommodating grooves 134a to 134d are formed in the upper surface of the second carrier 134, the second accommodating grooves 134a to 134d may be seated in engraved portions of corner regions where separate holes are not presented.

When the second accommodating grooves 134a to 134d are formed in the lower surface of the second carrier 134, the second accommodating grooves 134a to 134d may be engraved and formed together with holes (H1, H2, H3, and H4) of the corner regions, and contact with a guide ball 1333. For example, FIG. 11 is a front view of the second carrier 134 viewed from above, and may be in a state in which the second guide plate 1335 is coupled to the second accommodating grooves 134a to 134d that are in a front surface and opposite surface of the second carrier 134. The second guide plate 1335 may be partially exposed by the holes (H1, H2, H3, H4, and FIG. 10) of the corner regions, and thus the guide ball 1333 may be seated in contact.

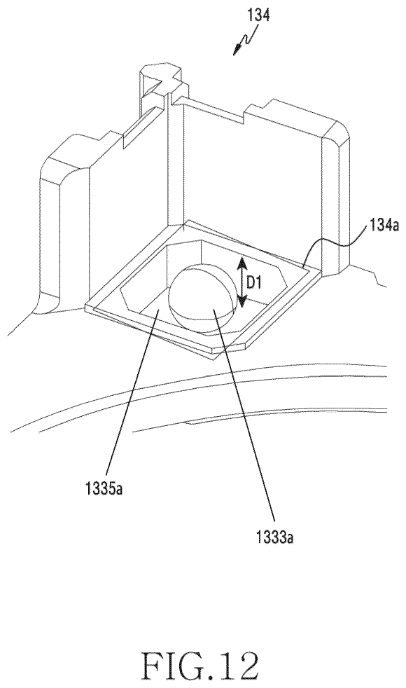

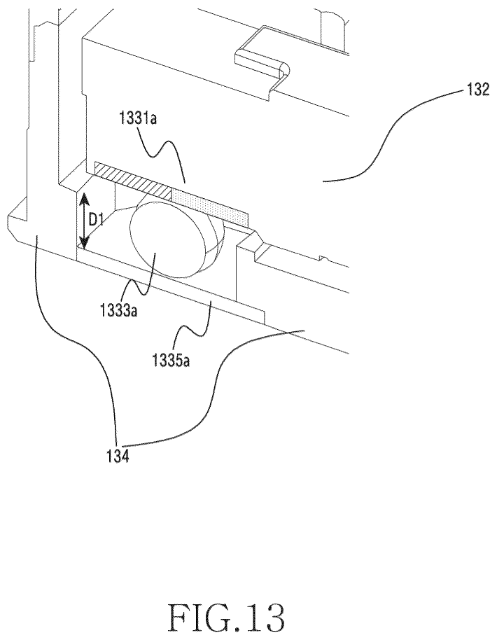

FIG. 12 is a diagram for explaining a state in which a guide ball is seated in an accommodating space of a second carrier according to an embodiment, and FIG. 13 is a diagram for explaining a state of coupling between a first carrier and a second carrier according to an embodiment.

Referring to FIG. 12, a second accommodating groove 134a and a hole that is a space for accommodating a guide ball 1333a may be formed in a corner region that is a part of the second carrier 134. The second accommodating groove 134a may be engraved and formed in a lower surface of the second carrier 134 wherein a 2-1st guide plate 1335a may be exposed through the hole.

Referring to FIG. 13, the hole for accommodating the guide ball 1333a may be formed to have a preset height (D1) wherein part of the guide ball 1333a is exposed. When the second carrier 134 is coupled to the first carrier 132, the guide ball 1333a may contact with a 1-1 st guide plate 1331a.

The first carrier 132 of an embodiment may have a plurality of first accommodating grooves 132a to 132d formed in a plurality of corner regions, respectively. The first guide plates 1331a to 1331d may be coupled to a lower surface of the first carrier 132, in the plurality of first accommodating grooves 132a to 132d, respectively. The second carrier 134 of an embodiment may have a plurality of second accommodating grooves 134a to 134d formed in a plurality of corner regions, respectively. The plurality of second accommodating grooves 134a to 134d may be formed in an upper surface or lower surface of the second carrier 134. When the plurality of second accommodating grooves 134a to 134d are formed in the upper surface of the second carrier 134, the second guide plates 1335a to 1335d may be seated on the upper surface of the second carrier 134. When the plurality of second accommodating grooves 134a to 134d are formed in the lower surface of the second carrier 134, the second guide plates 1335a to 1335d may be coupled to the lower surface of the second carrier 134.

A method for a camera module to perform OIS includes a lens shift method and a sensor shift method. The lens shift method is a method of moving a lens assembly by using a motor or an electromagnet, and the sensor shift method is a method of moving an image sensor through an actuator or a motor. In FIGS. 4 to 13, the construction, arrangement, and operations of the guide unit 133 have been described based on the lens shift method, but it goes without saying that the same principle may be applied to the sensor shift method.

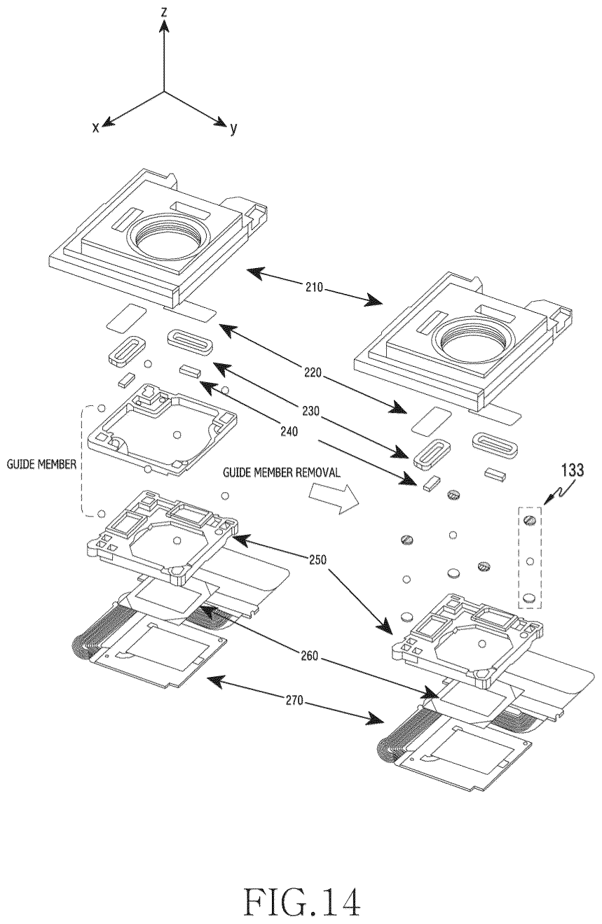

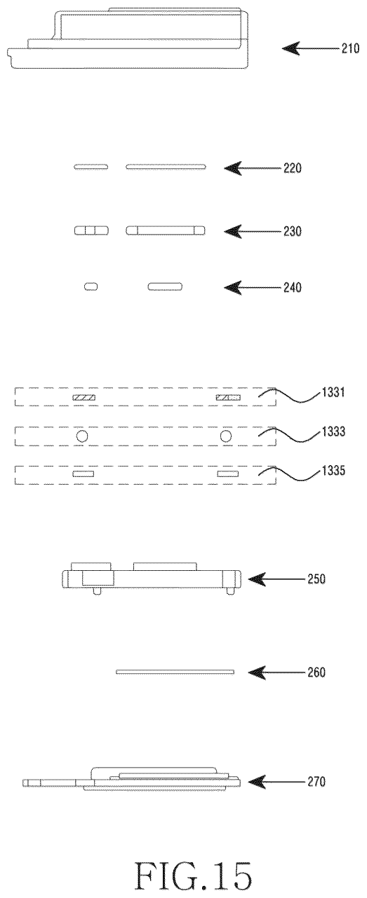

FIGS. 14 and 15 illustrate the construction of a camera module including a guide unit according to an embodiment when using a sensor shift method.

FIGS. 14 and 15 are diagrams for explaining a relationship of arrangement of the guide unit 133, and some components have been omitted, and the construction of FIGS. 14 and 15 may further include additional components for sensor shifting.

In a camera module 1980 of an embodiment, the guide unit 133 may be arranged between a camera housing 210 and a sensor carrier 250, in place of the guide member.

The camera module 1980 of this embodiment adopts a sensor shift method for OIS operation. The camera module 1980 of an embodiment may include the sensor carrier 250.

The camera housing 210 may include a base member and a cover member, and may substantially form an exterior of the camera module 1980.

An image sensor 270 may be disposed on the base member. In a camera module of a comparative example, an image sensor is fixed in position with being arranged in a housing (e.g., base member), whereas in the camera module 1980 of FIG. 14, the image sensor 270 may be changed in position with being disposed on the base member. The image sensor 270 may move in X-axis, Y-axis, and/or Z-axis directions by a sensor carrier 250. A filter 260 may be additionally disposed on the image sensor 270. The sensor carrier 250 may allow the image sensor 270 to move independently in three-axis directions (e.g., the X-axis, Y-axis, and/or Z-axis directions) of a space coordinate.

The camera module 1980 may include OIS magnets fixed to side surfaces (e.g., an outer side surface of +x direction and an outer side surface of +y direction) of the sensor carrier 250, and an OIS coil 230 fixed to an inner surface of the camera housing 210 and facing a first OIS magnet. Also, the camera module 1980 may include a position sensor 240 disposed on a surface that faces the inner surface of the camera housing 210. The position sensor 240 may be a Hall sensor. A PCB 220 may be electrically connected to the OIS coil 230 and the position sensor 240, wherein current is applied to the OIS coil 230, based on a signal acquired from the position sensor 240. When current is applied to the OIS coil 230, the sensor carrier 250 may move the base member (circuit board) on which the image sensor 270 is disposed, and move the image sensor 270 in an optical axis or a direction substantially perpendicular to an optical axis.

A first guide plate 1331 of an embodiment may be attached to a lower surface of the camera housing 210, and a second guide plate 1335 of an embodiment may be attached to an upper surface of the sensor carrier 250. The camera housing 210 may be coupled to the sensor carrier 250 through an assembly process, whereby a guide ball 1333 may be accommodated between the camera housing 210 and the sensor carrier 250 with contacting between the first guide plate 1331 and the second guide plate 1335.

For example, the guide unit 133 may operate according to the same principle, even when the camera module adopts the sensor shift method rather than the lens shift method. However, only positions to which the first guide plate 1331 and the second guide plate 1335 are attached may be different.

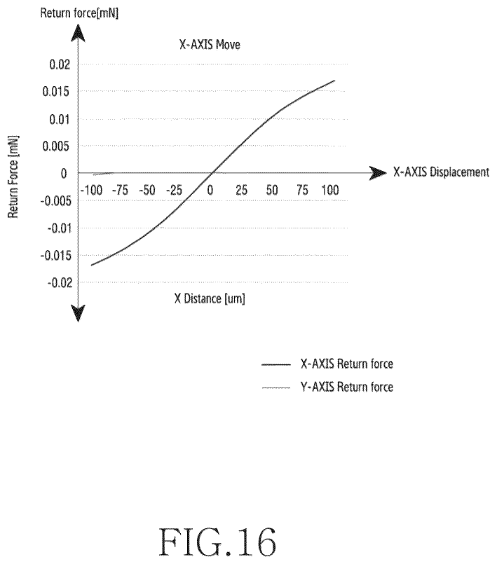

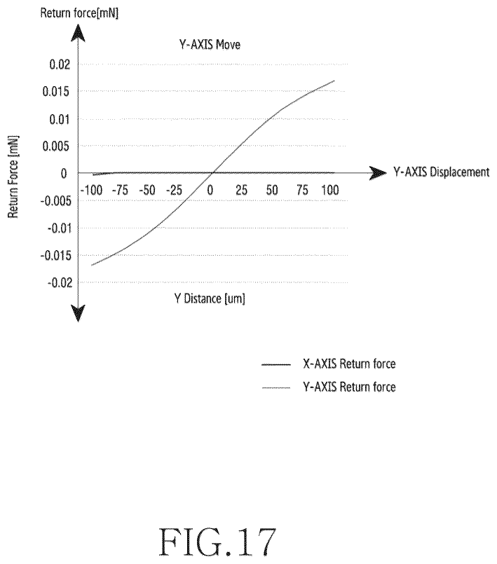

FIGS. 16 and 17 illustrate a relationship between a carrier movement and a return force. The description of FIGS. 16 and 17 will be made with reference to FIG. 2.

Referring to FIG. 16, a return force when the first guide unit 133a and the third guide unit 133c shown in FIG. 2 move in a y-axis direction is illustrated. When a relative movement between a first carrier 132 and a second carrier 134 occurs in an x-axis direction, a return force is provided in the x-axis direction that is a direction orthogonal to a neutral zone (NZ), but a return force is not provided in the y-axis direction that is a direction parallel to the neutral zone (NZ).

Referring to FIG. 17, a return force when the second guide unit 133b and the fourth guide unit 133d shown in FIG. 2 move in an x-axis direction is illustrated. When a relative movement between the first carrier 132 and the second carrier 134 occurs in the y-axis direction, a return force is provided in the y-axis direction that is a direction orthogonal to the neutral zone (NZ), but a return force is not provided in the x-axis direction that is a direction parallel to the neutral zone (NZ). Accordingly, a lens assembly 110 or image sensor 270 of a camera module 1980 may move on a plane with an optical axis maintained perpendicular to the ground, without a separate guide member.

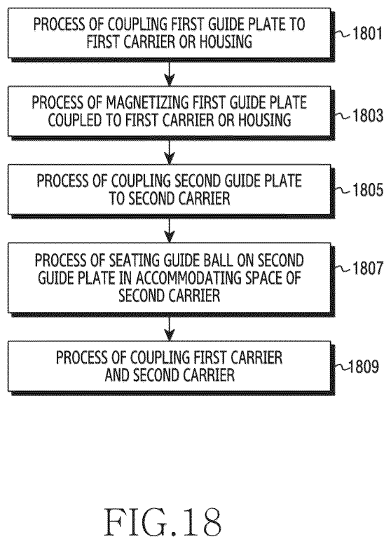

FIG. 18 is a flowchart of a process of manufacturing a camera module according to an embodiment. However, this is only an embodiment intended to achieve an object of the disclosure, and it goes without saying that some processes may be added or deleted or order may be changed, according to need.

A method of manufacturing a camera module 1980 of an embodiment may include a process 1801 of coupling a first guide plate to a first carrier or a housing. When the camera module 1980 of an embodiment has a structure adopting a lens shift method, the first guide plate 1331 may be coupled to the first carrier 132 that is an OIS carrier. When the camera module 1980 of an embodiment has a structure adopting a sensor shift method, the first guide plate 1331 may be coupled to the camera housing 210.

The method of manufacturing the camera module 1980 according to an embodiment may include a process 1803 of magnetizing the first guide plate 1331 coupled to the first carrier 132 or camera housing 210.

The first guide plate 1331 of an embodiment may become in a state of being magnetized through a magnetization process, after the first guide plate 1331 is coupled to the first carrier 132 or housing 210 in a non-magnetized state. The first guide plate 1331 of an embodiment may be subjected to the magnetization process and be a bipolar magnet, after being coupled to first accommodating grooves 132a to 132d formed in the first carrier 132 or housing 210. At this time, the magnetization process may be performed on a 1-1st guide plate 1331a and a 1-3rd guide plate 1331c in a first direction, and the magnetization process may be performed on a 1-2nd guide plate 1331b and a 1-4th guide plate 1331d in a second direction orthogonal to the first direction. An array of magnets in which magnetization has been completed refers to FIG. 9. It is possible that the first guide plate 1331 may also be coupled to the first carrier 132 or housing 210, in a state of being already magnetized before being coupled to the first carrier 132 or housing 210.

The method of manufacturing the camera module 1980 of an embodiment may include a process 1805 of coupling a second guide plate 1335 to a second carrier 134.

When the camera module 1980 of an embodiment has a structure adopting the lens shift method, the second guide plate 1335 may be coupled to an AF carrier 134. When the camera module 1980 of an embodiment has a structure adopting the sensor shift method, the first guide plate 1331 may be coupled to a sensor carrier 250.

The method of manufacturing the camera module 1980 of an embodiment may include a process 1807 of seating a guide ball 1333 on the second guide plate in an accommodating space of the second carrier (AF carrier 134 or sensor carrier 250).

The method of manufacturing the camera module 1980 of an embodiment may include a process 1809 of coupling the first carrier 132 to the second carrier 134. When the camera module 1980 of an embodiment adopts the sensor shift method rather than the lens shift method, the process 1809 may be replaced with a process of coupling the housing 210 to the sensor carrier 250, in that the first guide plate 1331 is coupled to the housing 210 and the second guide plate 1335 is coupled to the sensor carrier 250.

When the camera module 1980 of an embodiment has the structure adopting the lens shift method, the OIS carrier (first carrier 132) may be coupled onto the AF carrier (second carrier 134). When the camera module 1980 of an embodiment has the structure adopting the sensor shift method, the housing 210 may be coupled onto the sensor carrier 250. A structure of coupling between the carriers or between the carrier and the housing refers to FIG. 13.

An electronic device (e.g., 101 of FIG. 1) of an embodiment may include a camera module (e.g., 1980 of FIGS. 19 and 20). The camera module (e.g., 1980 of FIGS. 19 and 20) of an embodiment may include a lens assembly (e.g., 110 of FIGS. 4, 6 and 7) aligned along an optical axis, a first carrier (e.g., 132 of FIGS. 4 to 8) coupled to the lens assembly (e.g., 110 of FIGS. 4, 6 and 7), a second carrier (e.g., 134 of FIGS. 4 to 7) coupled to the first carrier (e.g., 132 of FIGS. 4 to 8), a first guide plate (e.g., 1331a to 1331d of FIGS. 8 and 9) coupled to a first accommodating groove (e.g., 132a to 132d of FIGS. 8 and 9) formed in the first carrier (e.g., 132 of FIGS. 4 to 8), a second guide plate (e.g., 1335a to 1335d of FIGS. 10 and 11) coupled to a second accommodating groove (e.g., 134a to 134d of FIGS. 10 and 11) formed in the second carrier (e.g., 134 of FIGS. 4 to 7), and a guide ball (e.g., 1333 of FIGS. 3, 5 and 13) seated on a second surface of the second guide plate (e.g., 1335a to 1335d of FIGS. 10 and 11) and accommodated in at least part of a space formed by the second carrier (e.g., 134 of FIGS. 4 to 7), and contacting with the first guide plate (e.g., 1331a to 1331d of FIGS. 8 and 9) having a first surface that faces the second surface.

The first guide plate (e.g., 1331a to 1331d of FIGS. 8 and 9) of an embodiment may be comprised of a dipole magnet. The second guide plate (e.g., 1335a to 1335d of FIGS. 10 and 11) and the guide ball (e.g., 1333 of FIGS. 3, 5 and 13) of an embodiment may be comprised of a ferromagnet. The first guide plate (e.g., 1331a to 1331d of FIGS. 8 and 9) of an embodiment may be comprised of a dipole magnet, and include a 1-1st guide plate (e.g., 1331a of FIGS. 8 and 9), a 1-2nd guide plate (e.g., 1331b of FIGS. 8 and 9), a 1-3rd guide plate (e.g., 1331c of FIGS. 8 and 9), and a 1-4th guide plate (e.g., 1331d of FIGS. 8 and 9). The 1-1st guide plate (e.g., 1331a of FIGS. 8 and 9), 1-2nd guide plate (e.g., 1331b of FIGS. 8 and 9), 1-3rd guide plate (e.g., 1331c of FIGS. 8 and 9), and 1-4th guide plate (e.g., 1331d of FIGS. 8 and 9) of an embodiment may be arranged in a plurality of corner regions of the first carrier (e.g., 132 of FIGS. 4 to 8) respectively. The 1-1st guide plate (e.g., 1331a of FIGS. 8 and 9) may be positioned diagonally to the 1-3rd guide plate (e.g., 1331c of FIGS. 8 and 9). A first boundary line dividing the N pole and the S pole of the 1-1st guide plate (e.g., 1331a of FIGS. 8 and 9) may be orthogonal to a second boundary line dividing the N pole and the S pole of the 1-2nd guide plate (e.g., 1331b of FIGS. 8 and 9).

The first guide plate (e.g., 1331a to 1331d of FIGS. 8 and 9) of an embodiment may be comprised of a dipole magnet including the N pole and the S pole, present a neutral zone (e.g., NZ of FIG. 4) where the guide ball (e.g., 1333 of FIGS. 3, 5 and 13) may move along a boundary line between the N pole and the S pole, and present a return force when the guide ball (e.g., 1333 of FIGS. 3, 5 and 13) moves perpendicular to the boundary line.

A plurality of first accommodating grooves (e.g., 132a to 132d of FIGS. 8 and 9) may be formed in a plurality of corner regions of the first carrier (e.g., 132 of FIGS. 4 to 8) of an embodiment, and a plurality of first guide plates (e.g., 1331a to 1331d of FIGS. 8 and 9) may be coupled to the first surface in the plurality of first accommodating grooves (e.g., 132a to 132d of FIGS. 8 and 9), respectively. A plurality of second accommodating grooves (e.g., 134a to 134d of FIGS. 10 and 11) may be formed in a plurality of corner regions of the second carrier (e.g., 134 of FIGS. 4 to 7) of an embodiment. A plurality of second guide plates (e.g., 1335a to 1335d of FIGS. 10 and 11) may be coupled to the first surface or the second surface in the plurality of second accommodating grooves (e.g., 134a to 134d of FIGS. 10 and 11), respectively.

The first guide plate (e.g., 1331a to 1331d of FIGS. 8 and 9) and the second guide plate (e.g., 1335a to 1335d of FIGS. 10 and 11) of an embodiment may be comprised of a dipole magnet including the N pole and the S pole.

An N-pole region of the first guide plate (e.g., 1331a to 1331d of FIGS. 8 and 9) of an embodiment may extend along the optical axis and coincide with an S-pole region of the second guide plate (e.g., 1335a to 1335d of FIGS. 10 and 11), and an S-pole region of the first guide plate (e.g., 1331a to 1331d of FIGS. 8 and 9) may extend along the optical axis and coincide with an N-pole region of the second guide plate (e.g., 1335a to 1335d of FIGS. 10 and 11).

At least one of the first guide plate (e.g., 1331a to 1331d of FIGS. 8 and 9) or the second guide plate (e.g., 1335a to 1335d of FIGS. 10 and 11) of an embodiment may be formed in a circular shape. The guide ball (e.g., 1333 of FIGS. 3, 5 and 13) of an embodiment may be comprised of a ferromagnet having a spherical shape. The diameter of the circular shape may be formed larger than the diameter of the spherical shape.

At least one of the first guide plate (e.g., 1331a to 1331d of FIGS. 8 and 9) or the second guide plate (e.g., 1335a to 1335d of FIGS. 10 and 11) of an embodiment may be formed in a square shape. The guide ball (e.g., 1333 of FIGS. 3, 5 and 13) of an embodiment may be comprised of a ferromagnet having a spherical shape. The length of a side of the square shape may be formed larger than the diameter of the spherical shape.

At least one of the first plate (e.g., 1331a to 1331d of FIGS. 8 and 9) or the second guide plate (e.g., 1335a to 1335d of FIGS. 10 and 11) of an embodiment may be formed in an oval shape.

The guide ball (e.g., 1333 of FIGS. 3, 5 and 13) of an embodiment may be comprised of a ferromagnet having a spherical shape. At least one of the first plate (e.g., 1331a to 1331d of FIGS. 8 and 9) or the second guide plate (e.g., 1335a to 1335d of FIGS. 10 and 11) of an embodiment may be comprised of a dipole magnet including the N pole and the S pole, and present a neutral zone (e.g., NZ of FIG. 4) where the guide ball (e.g., 1333 of FIGS. 3, 5 and 13) may move along a boundary line between the N pole and the S pole. The neutral zone (e.g., NZ of FIG. 4) may be formed on a long axis of the oval-shaped first guide plate or second guide plate.

The first guide plate (e.g., 1331a to 1331d of FIGS. 8 and 9) of an embodiment may be subjected to a magnetization process and become a dipole magnet, after being coupled to the first accommodating groove (e.g., 132a to 132d of FIGS. 8 and 9) formed in the first carrier (e.g., 132 of FIGS. 4 to 8).

The first carrier (e.g., 132 of FIGS. 4 to 8) of an embodiment may include an OIS carrier that moves the lens assembly (e.g., 110 of FIGS. 4, 6 and 7) on a plane perpendicular to the optical axis. The second carrier (e.g., 134 of FIGS. 4 to 7) may include an AF carrier that moves the lens assembly (e.g., 110 of FIGS. 4, 6 and 7) in an optical-axis direction.

An electronic device (e.g., 101 of FIG. 1) of an embodiment may include a camera module (e.g., 1980 of FIGS. 19 and 20). The camera module (e.g., 1980 of FIGS. 19 and 20) of an embodiment may include a lens assembly aligned along an optical axis, a housing (e.g., 210 of FIGS. 14 and 15) accommodating the lens assembly, a circuit board on which an image sensor (e.g., 270 of FIGS. 14 and 15) is disposed, a carrier (e.g., 250 of FIGS. 14 and 15) configured to move the circuit board within the camera module (e.g., 1980 of FIGS. 19 and 20) in an optical-axis direction and the direction crossing an optical axis, a first guide plate (e.g., 1331 of FIG. 3) coupled to a first accommodating groove formed in the housing (e.g., 210 of FIGS. 14 and 15), a second guide plate (e.g., 1335 of FIG. 3) coupled to a second accommodating groove formed in the carrier (e.g., 250 of FIGS. 14 and 15), and a guide ball (e.g., 1333 of FIG. 3) seated on a second surface of the second guide plate (e.g., 1335 of FIG. 3) and accommodated in at least part of a space formed by the carrier, and contacting with the first guide plate (e.g., 1331 of FIG. 3) having a first surface that faces the second surface.

The first guide plate (e.g., 1331 of FIG. 3) of an embodiment may be comprised of a dipole magnet. The second guide plate (e.g., 1335 of FIG. 3) and the guide ball (e.g., 1333 of FIG. 3) of an embodiment may be comprised of a ferromagnet.

The first guide plate (e.g., 1331 of FIG. 3) of an embodiment may include a 1-1st guide plate, a 1-2nd guide plate, a 1-3rd guide plate, and a 1-4th guide plate. The 1-1st guide plate, the 1-2nd guide plate, the 1-3rd guide plate, and the 1-4th guide plate may be arranged in a plurality of corner regions of the first carrier, respectively. The 1-1st guide plate may be positioned diagonally to the 1-3rd guide plate. A first boundary line dividing the N pole and the S pole of the 1-1st guide plate (e.g., 1331a of FIGS. 8 and 9) may be orthogonal to a second boundary line dividing the N pole and the S pole of the 1-2nd guide plate (e.g., 1331b of FIGS. 8 and 9).

The first guide plate (e.g., 1331 of FIG. 3) of an embodiment may be comprised of a dipole magnet including the N pole and the S pole, present a neutral zone where the guide ball (e.g., 1333 of FIG. 3) may move along a boundary line between the N pole and the S pole, and present a return force when the guide ball (e.g., 1333 of FIG. 3) moves perpendicular to the boundary line.

A plurality of first accommodating grooves may be formed in a plurality of corner regions of the housing (e.g., 210 of FIGS. 14 and 15) of an embodiment, and a plurality of first guide plates (e.g., 1331 of FIG. 3) may be coupled to the first surface in the plurality of first accommodating grooves, respectively. A plurality of second accommodating grooves may be formed in a plurality of corner regions of the carrier (e.g., 250 of FIGS. 14 and 15) of an embodiment, and a plurality of second guide plates (e.g., 1335 of FIG. 3) may be coupled to the first surface or the second surface in the plurality of second accommodating grooves, respectively.

A method of manufacturing a camera module (e.g., 1980 of FIGS. 19 and 20) of an embodiment may include a first coupling process (e.g., 1801 of FIG. 18) of coupling a first guide plate to a lower surface of a first carrier. The manufacturing method of an embodiment may include a second coupling process (e.g., 1805 of FIG. 18) of coupling a second guide plate to an upper surface or lower surface of a second carrier. The manufacturing method of an embodiment may include a seating process (e.g., 1807 of FIG. 18) of placing a guide ball on the second guide plate in an accommodating space of the second carrier. The manufacturing method of an embodiment may include a third coupling process (e.g., 1809 of FIG. 18) of coupling the first carrier and the second carrier and arranging the guide ball between the first guide plate and the second guide plate.

The first coupling process of an embodiment may include a magnetization process (e.g., 1803 of FIG. 18) of magnetizing the first guide plate, after coupling the first guide plate to an accommodating groove formed in the first carrier.

Effects obtainable from the disclosure are not limited to the effects mentioned above, and other effects not mentioned may be clearly understood by those skilled in the art to which the disclosure pertains from the description below.

FIG. 19 is a block diagram illustrating an electronic device 1901 in a network environment 1900 according to various embodiments.

Referring to FIG. 19, the electronic device 1901 in the network environment 1900 may communicate with an electronic device 1902 via a first network 1998 (e.g., a short-range wireless communication network), or at least one of an electronic device 1904 or a server 1908 via a second network 1999 (e.g., a long-range wireless communication network). According to an embodiment, the electronic device 1901 may communicate with the electronic device 1904 via the server 1908. According to an embodiment, the electronic device 1901 may include a processor 1920, memory 1930, an input module 1950, a sound output module 1955, a display module 1960, an audio module 1970, a sensor module 1976, an interface 1977, a connecting terminal 1978, a haptic module 1979, a camera module 1980, a power management module 1988, a battery 1989, a communication module 1990, a subscriber identification module (SIM) 1996, or an antenna module 1997. In one or more embodiments, at least one of the components (e.g., the connecting terminal 1978) may be omitted from the electronic device 1901, or one or more other components may be added in the electronic device 1901. In one or more embodiments, some of the components (e.g., the sensor module 1976, the camera module 1980, or the antenna module 1997) may be implemented as a single component (e.g., the display module 1960).

The processor 1920 may execute, for example, software (e.g., a program 1940) to control at least one other component (e.g., a hardware or software component) of the electronic device 1901 coupled with the processor 1920, and may perform various data processing or computation. According to an embodiment, as at least part of the data processing or computation, the processor 1920 may store a command or data received from another component (e.g., the sensor module 1976 or the communication module 1990) in volatile memory 1932, process the command or the data stored in the volatile memory 1932, and store resulting data in non-volatile memory 1934. According to an embodiment, the processor 1920 may include a main processor 1921 (e.g., a central processing unit (CPU) or an application processor (AP)), or an auxiliary processor 1923 (e.g., a graphics processing unit (GPU), a neural processing unit (NPU), an image signal processor (ISP), a sensor hub processor, or a communication processor (CP)) that is operable independently from, or in conjunction with, the main processor 1921. For example, when the electronic device 1901 includes the main processor 1921 and the auxiliary processor 1923, the auxiliary processor 1923 may be adapted to consume less power than the main processor 1921, or to be specific to a specified function. The auxiliary processor 1923 may be implemented as separate from, or as part of the main processor 1921.

The auxiliary processor 1923 may control at least some of functions or states related to at least one component (e.g., the display module 1960, the sensor module 1976, or the communication module 1990) among the components of the electronic device 1901, instead of the main processor 1921 while the main processor 1921 is in an inactive (e.g., sleep) state, or together with the main processor 1921 while the main processor 1921 is in an active state (e.g., executing an application). According to an embodiment, the auxiliary processor 1923 (e.g., an image signal processor or a communication processor) may be implemented as part of another component (e.g., the camera module 1980 or the communication module 1990) functionally related to the auxiliary processor 1923. According to an embodiment, the auxiliary processor 1923 (e.g., the neural processing unit) may include a hardware structure specified for artificial intelligence model processing. An artificial intelligence model may be generated by machine learning. Such learning may be performed, e.g., by the electronic device 1901 where the artificial intelligence is performed or via a separate server (e.g., the server 1908). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1930 may store various data used by at least one component (e.g., the processor 1920 or the sensor module 1976) of the electronic device 1901. The various data may include, for example, software (e.g., the program 1940) and input data or output data for a command related thererto. The memory 1930 may include the volatile memory 1932 or the non-volatile memory 1934.

The program 1940 may be stored in the memory 1930 as software, and may include, for example, an operating system (OS) 1942, middleware 1944, or an application 1946.

The input module 1950 may receive a command or data to be used by another component (e.g., the processor 1920) of the electronic device 1901, from the outside (e.g., a user) of the electronic device 1901. The input module 1950 may include, for example, a microphone, a mouse, a keyboard, a key (e.g., a button), or a digital pen (e.g., a stylus pen).

The sound output module 1955 may output sound signals to the outside of the electronic device 1901. The sound output module 1955 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1960 may visually provide information to the outside (e.g., a user) of the electronic device 1901. The display module 1960 may include, for example, a display, a hologram device, or a projector and control circuitry to control a corresponding one of the display, hologram device, and projector. According to an embodiment, the display module 1960 may include a touch sensor adapted to detect a touch, or a pressure sensor adapted to measure the intensity of force incurred by the touch.

The audio module 1970 may convert a sound into an electrical signal and vice versa. According to an embodiment, the audio module 1970 may obtain the sound via the input module 1950, or output the sound via the sound output module 1955 or a headphone of an external electronic device (e.g., an electronic device 1902) directly (e.g., wiredly) or wirelessly coupled with the electronic device 1901.

The sensor module 1976 may detect an operational state (e.g., power or temperature) of the electronic device 1901 or an environmental state (e.g., a state of a user) external to the electronic device 1901, and then generate an electrical signal or data value corresponding to the detected state. According to an embodiment, the sensor module 1976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1977 may support one or more specified protocols to be used for the electronic device 1901 to be coupled with the external electronic device (e.g., the electronic device 1902) directly (e.g., wiredly) or wirelessly. According to an embodiment, the interface 1977 may include, for example, a high definition multimedia interface (HDMI), a universal serial bus (USB) interface, a secure digital (SD) card interface, or an audio interface.

A connecting terminal 1978 may include a connector via which the electronic device 1901 may be physically connected with the external electronic device (e.g., the electronic device 1902). According to an embodiment, the connecting terminal 1978 may include, for example, a HDMI connector, a USB connector, a SD card connector, or an audio connector (e.g., a headphone connector).

The haptic module 1979 may convert an electrical signal into a mechanical stimulus (e.g., a vibration or a movement) or electrical stimulus which may be recognized by a user via his tactile sensation or kinesthetic sensation. According to an embodiment, the haptic module 1979 may include, for example, a motor, a piezoelectric element, or an electric stimulator.

The camera module 1980 may capture a still image or moving images. According to an embodiment, the camera module 1980 may include one or more lenses, image sensors, image signal processors, or flashes.

The power management module 1988 may manage power supplied to the electronic device 1901. According to an embodiment, the power management module 1988 may be implemented as at least part of, for example, a power management integrated circuit (PMIC).

The battery 1989 may supply power to at least one component of the electronic device 1901. According to an embodiment, the battery 1989 may include, for example, a primary cell which is not rechargeable, a secondary cell which is rechargeable, or a fuel cell.

The communication module 1990 may support establishing a direct (e.g., wired) communication channel or a wireless communication channel between the electronic device 1901 and the external electronic device (e.g., the electronic device 1902, the electronic device 1904, or the server 1908) and performing communication via the established communication channel. The communication module 1990 may include one or more communication processors that are operable independently from the processor 1920 (e.g., the application processor (AP)) and supports a direct (e.g., wired) communication or a wireless communication. According to an embodiment, the communication module 1990 may include a wireless communication module 1992 (e.g., a cellular communication module, a short-range wireless communication module, or a global navigation satellite system (GNSS) communication module) or a wired communication module 1994 (e.g., a local area network (LAN) communication module or a power line communication (PLC) module). A corresponding one of these communication modules may communicate with the external electronic device via the first network 1998 (e.g., a short-range communication network, such as Bluetooth™, wireless-fidelity (Wi-Fi) direct, or infrared data association (IrDA)) or the second network 1999 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1992 may identify and authenticate the electronic device 1901 in a communication network, such as the first network 1998 or the second network 1999, using subscriber information (e.g., international mobile subscriber identity (IMSI)) stored in the subscriber identification module 1996.

The wireless communication module 1992 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1992 may support a high-frequency band (e.g., the mmWave band) to achieve, e.g., a high data transmission rate. The wireless communication module 1992 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1992 may support various requirements specified in the electronic device 1901, an external electronic device (e.g., the electronic device 1904), or a network system (e.g., the second network 1999). According to an embodiment, the wireless communication module 1992 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1997 may transmit or receive a signal or power to or from the outside (e.g., the external electronic device) of the electronic device 1901. According to an embodiment, the antenna module 1997 may include an antenna including a radiating element composed of a conductive material or a conductive pattern formed in or on a substrate (e.g., a printed circuit board (PCB)). According to an embodiment, the antenna module 1997 may include a plurality of antennas (e.g., array antennas). In such a case, at least one antenna appropriate for a communication scheme used in the communication network, such as the first network 1998 or the second network 1999, may be selected, for example, by the communication module 1990 (e.g., the wireless communication module 1992) from the plurality of antennas. The signal or the power may then be transmitted or received between the communication module 1990 and the external electronic device via the selected at least one antenna. According to an embodiment, another component (e.g., a radio frequency integrated circuit (RFIC)) other than the radiating element may be additionally formed as part of the antenna module 1997.

According to various embodiments, the antenna module 1997 may form a mm Wave antenna module. According to an embodiment, the mmWave antenna module may include a printed circuit board, a RFIC disposed on a first surface (e.g., the bottom surface) of the printed circuit board, or adjacent to the first surface of the printed circuit board and capable of supporting a designated high-frequency band (e.g., the mmWave band), and a plurality of antennas (e.g., array antennas) disposed on a second surface (e.g., the top or a side surface) of the printed circuit board, or adjacent to the second surface of the printed circuit board and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1901 and the external electronic device 1904 via the server 1908 coupled with the second network 1999. Each of the electronic devices 1902 or 1904 may be a device of a same type as, or a different type, from the electronic device 1901. According to an embodiment, all or some of operations to be executed at the electronic device 1901 may be executed at one or more of the external electronic devices 1902, 1904, or 1908. For example, if the electronic device 1901 should perform a function or a service automatically, or in response to a request from a user or another device, the electronic device 1901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1901. The electronic device 1901 may provide the outcome, with or without further processing of the outcome, as at least part of a reply to the request. To that end, a cloud computing, distributed computing, mobile edge computing (MEC), or client-server computing technology may be used, for example. The electronic device 1901 may provide ultra low-latency services using, e.g., distributed computing or mobile edge computing. In another embodiment, the external electronic device 1904 may include an internet-of-things (IoT) device. The server 1908 may be an intelligent server using machine learning and/or a neural network. According to an embodiment, the external electronic device 1904 or the server 1908 may be included in the second network 1999. The electronic device 1901 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to.” “connected with.” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1940) including one or more instructions that are stored in a storage medium (e.g., internal memory 1936 or external memory 1938) that is readable by a machine (e.g., the electronic device 1901). For example, a processor (e.g., the processor 1920) of the machine (e.g., the electronic device 1901) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

FIG. 20 is a block diagram 2000 illustrating the camera module 1980 according to various embodiments.

Referring to FIG. 20, the camera module 1980 may include a lens assembly 2010, a flash 2020, an image sensor 2030, an image stabilizer 2040, memory 2050 (e.g., buffer memory), or an image signal processor 2060. The lens assembly 2010 may collect light emitted or reflected from an object whose image is to be taken. The lens assembly 2010 may include one or more lenses. According to an embodiment, the camera module 1980 may include a plurality of lens assemblies 2010. In such a case, the camera module 1980 may form, for example, a dual camera, a 360-degree camera, or a spherical camera. Some of the plurality of lens assemblies 2010 may have the same lens attribute (e.g., view angle, focal length, auto-focusing, f number, or optical zoom), or at least one lens assembly may have one or more lens attributes different from those of another lens assembly. The lens assembly 2010 may include, for example, a wide-angle lens or a telephoto lens.

The flash 2020 may emit light that is used to reinforce light reflected from an object. According to an embodiment, the flash 2020 may include one or more light emitting diodes (LEDs) (e.g., a red-green-blue (RGB) LED, a white LED, an infrared (IR) LED, or an ultraviolet (UV) LED) or a xenon lamp. The image sensor 2030 may obtain an image corresponding to an object by converting light emitted or reflected from the object and transmitted via the lens assembly 2010 into an electrical signal. According to an embodiment, the image sensor 2030 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 2030 may be implemented using, for example, a charged coupled device (CCD) sensor or a complementary metal oxide semiconductor (CMOS) sensor.

The image stabilizer 2040 may move the image sensor 2030 or at least one lens included in the lens assembly 2010 in a particular direction, or control an operational attribute (e.g., adjust the read-out timing) of the image sensor 2030 in response to the movement of the camera module 1980 or the electronic device 1901 including the camera module 1980. This allows compensating for at least part of a negative effect (e.g., image blurring) by the movement on an image being captured. According to an embodiment, the image stabilizer 2040 may sense such a movement by the camera module 1980 or the electronic device 1901 using a gyro sensor or an acceleration sensor disposed inside or outside the camera module 1980. According to an embodiment, the image stabilizer 2040 may be implemented, for example, as an optical image stabilizer. The memory 2050 may store, at least temporarily, at least part of an image obtained via the image sensor 2030 for a subsequent image processing task. For example, if image capturing is delayed due to shutter lag or multiple images are quickly captured, a raw image obtained (e.g., a Bayer-patterned image, a high-resolution image) may be stored in the memory 2050, and its corresponding copy image (e.g., a low-resolution image) may be previewed via the display module 1960. Thereafter, if a specified condition is met (e.g., by a user's input or system command), at least part of the raw image stored in the memory 2050 may be obtained and processed, for example, by the image signal processor 2060. According to an embodiment, the memory 2050 may be configured as at least part of the memory 1930 or as a separate memory that is operated independently from the memory 1930.

The image signal processor 2060 may perform one or more image processing with respect to an image obtained via the image sensor 2030 or an image stored in the memory 2050. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 2060 may perform control (e.g., exposure time control or read-out timing control) with respect to at least one (e.g., the image sensor 2030) of the components included in the camera module 1980. An image processed by the image signal processor 2060 may be stored back in the memory 2050 for further processing, or may be provided to an external component (e.g., the memory 1930, the display module 1960, the electronic device 1902, the electronic device 1904, or the server 1908) outside the camera module 1980. According to an embodiment, the image signal processor 2060 may be configured as at least part of the processor 1920, or as a separate processor that is operated independently from the processor 1920. If the image signal processor 2060 is configured as a separate processor from the processor 1920, at least one image processed by the image signal processor 2060 may be displayed, by the processor 1920, via the display module 1960 as it is or after being further processed.

According to an embodiment, the electronic device 1901 may include a plurality of camera modules 1980 having different attributes or functions. In such a case, at least one of the plurality of camera modules 1980 may form, for example, a wide-angle camera and at least another of the plurality of camera modules 1980 may form a telephoto camera. Similarly, at least one of the plurality of camera modules 1980 may form, for example, a front camera and at least another of the plurality of camera modules 1980 may form a rear camera.

What is claimed is:

1. An electronic device comprising:
a camera module, wherein the camera module comprises:
a lens assembly aligned along an optical axis;
a first carrier coupled to the lens assembly and having a first accommodating groove therein;
a second carrier coupled to the first carrier and having a second accommodating groove therein;
at least one first guide plate coupled to the first accommodating groove in the first carrier, the at least one first guide plate having a first surface;
at least one second guide plate coupled to the second accommodating groove in the second carrier, the at least one second guide plate having a second surface that faces the first surface of the at least one first guide plate; and
a guide ball on the second surface of the at least one second guide plate and accommodated in at least part of a space formed by the second carrier, the guide ball contacting the first surface of the at least one first guide plate.

2. The electronic device of claim 1, wherein the at least one first guide plate comprises a dipole magnet, and
wherein each of the at least one second guide plate and the guide ball comprises a ferromagnet.

3. The electronic device of claim 1, wherein the at least one first guide plate comprises a first-first guide plate, a second-first guide plate, a third-first guide plate, and a fourth-first guide plate,
wherein each of the first-first guide plate, the second-first guide plate, the third-first guide plate, and the fourth-first guide plate comprises a dipole magnet,
wherein the first-first guide plate, the second-first guide plate, the third-first guide plate, and the fourth-first guide plate are respectively arranged in a plurality of corner regions of the first carrier,
wherein the first-first guide plate is positioned diagonally with respect to the third-first guide plate, and
wherein a first boundary line dividing a north pole and a south pole of the first-first guide plate is orthogonal to a second boundary line dividing a north pole and a south pole of the second-first guide plate.

4. The electronic device of claim 1, wherein the at least one first guide plate comprises a dipole magnet comprising a north pole and a south pole, and
wherein the at least one first guide plate is configured to allow the guide ball to move along a boundary line between the north pole and the south pole and to assert a return force when the guide ball moves perpendicular to the boundary line.

5. The electronic device of claim 1, wherein the at least one first guide plate comprises a plurality of first guide plates,
wherein the at least one second guide plate comprises a plurality of second guide plates,
wherein the first carrier has a plurality of first accommodating grooves in a plurality of corner regions thereof, and the plurality of first guide plates are respectively coupled to the plurality of first accommodating grooves, and
wherein the second carrier has a plurality of second accommodating grooves in a plurality of corner regions thereof, and the plurality of second guide plates are respectively coupled to the plurality of second accommodating grooves.

6. The electronic device of claim 1, wherein each of the at least one first guide plate and the at least one second guide plate comprises a dipole magnet comprising a north pole and a south pole.

7. The electronic device of claim 6, wherein a north-pole region of the at least one first guide plate extends along the optical axis and coincides with a south-pole region of the at least one second guide plate, and
wherein a south-pole region of the at least one first guide plate extends along the optical axis and coincides with a north-pole region of the at least one second guide plate.

8. The electronic device of claim 1, wherein at least one of the at least one first guide plate or the at least one second guide plate has a circular shape,
wherein the guide ball comprises a ferromagnet comprising a spherical shape, and
wherein a diameter of the circular shape is larger than a diameter of the spherical shape.

9. The electronic device of claim 1, wherein at least one of the at least one first guide plate or the at least one second guide plate has a square shape,
wherein the guide ball comprises a ferromagnet having a spherical shape, and
wherein a length of a side of the square shape is larger than a diameter of the spherical shape.

10. The electronic device of claim 1, wherein at least one of the at least one first guide plate or the at least one second guide plate comprises an oval shape.

11. The electronic device of claim 10, wherein the guide ball comprises a ferromagnet having a spherical shape, and
wherein at least one of the at least one first guide plate or the at least one second guide plate comprises a dipole magnet comprising a north pole, a south pole, and a neutral zone where the guide ball may move along a boundary line between the north pole and the south pole, the neutral zone being formed on a long axis of the at least one of the at least one first guide plate or the at least one second guide plate comprising the oval shape.

12. The electronic device of claim 1, wherein the at least one first guide plate comprises a dipole magnet formed via a magnetization process applied to the at least one first guide plate after the at least one first guide plate is coupled to the first accommodating groove.

13. The electronic device of claim 1, wherein the first carrier comprises an optical image stabilization carrier configured to move the lens assembly on a plane perpendicular to the optical axis, and
wherein the second carrier comprises an auto focus carrier configured to move the lens assembly in an optical-axis direction.

14. An electronic device comprising:
a camera module, wherein the camera module comprises:
a lens assembly aligned along an optical axis;
a housing accommodating the lens assembly and having a first accommodating groove therein;
a circuit board on which an image sensor is disposed;
a carrier configured to move the circuit board within the camera module in an optical-axis direction and a direction crossing the optical axis, the carrier having a second accommodating groove therein;
at least one first guide plate coupled to the first accommodating groove in the housing, the at least one first guide plate having a first surface;
at least one second guide plate coupled to the second accommodating groove in the carrier, the at least one second guide plate having a second surface that faces the first surface of the at least one first guide plate; and
a guide ball on the second surface of the at least one second guide plate and accommodated in at least part of a space formed by the carrier, the guide ball contacting with the first surface of the at least one first guide plate.

15. The electronic device of claim 14, wherein the at least one first guide plate comprises a dipole magnet, and
wherein each of the at least one second guide plate and the guide ball comprises a ferromagnet.

16. The electronic device of claim 14, wherein the at least one first guide plate comprises a first-first guide plate, a second-first guide plate, a third-first guide plate, and a fourth-first guide plate,
wherein each of the first-first guide plate, the second-first guide plate, the third-first guide plate, and the fourth-first guide plate comprises a dipole magnet,
wherein the first-first guide plate, the second-first guide plate, the third-first guide plate, and the fourth-first guide plate are respectively arranged in a plurality of corner regions of the housing,
wherein the first-first guide plate is positioned diagonally with respect to the third-first guide plate, and
wherein a first boundary line dividing a north pole and a south pole of the first-first guide plate is orthogonal to a second boundary line dividing a north pole and a south pole of the second-first guide plate.

17. The electronic device of claim 14, wherein the at least one first guide plate comprises a dipole magnet comprising a north pole and a south pole, and
wherein the at least one first guide plate is configured to allow the guide ball to move along a boundary line between the north pole and the south pole, and to assert a return force when the guide ball moves perpendicular to the boundary line.

18. The electronic device of claim 14, wherein the at least one first guide plate comprises a plurality of first guide plates,
wherein the at least one second guide plate comprises a plurality of second guide plates,
wherein the housing has a plurality of first accommodating grooves in a plurality of corner regions thereof, and the plurality of first guide plates are respectively coupled to the plurality of first accommodating grooves, and
wherein the carrier has a plurality of second accommodating grooves in a plurality of corner regions thereof, and the plurality of second guide plates are respectively coupled to the plurality of second accommodating grooves.

19. A method of manufacturing a camera module, the method comprising:
coupling a first guide plate to a lower surface of a first carrier;
coupling a second guide plate to an upper surface or a lower surface of a second carrier;
placing a guide ball on the second guide plate in an accommodating space of the second carrier; and
coupling the first carrier and the second carrier such that the guide ball is between the first guide plate and the second guide plate.

20. The method of claim 19, wherein the coupling the first guide plate to the lower surface of the first carrier comprises:
coupling the first guide plate to an accommodating groove formed in the first carrier; and
magnetizing the first guide plate after the coupling the first guide plate to the accommodating groove.
